(19) United States
(12) Patent Application Publication
(10) Pub. No.: US 2020/0302520 A1
(43) Pub. Date: Sep. 24, 2020

(54) METHOD AND SYSTEM FOR FACILITATING PEER-TO-PEER PAYMENTS

(71) Applicant: MASTERCARD INTERNATIONAL INCORPORATED, Purchase, NY (US)

(72) Inventors: Harsh Piparsaniya, Pune (IN); Sudhir Gupta, Pune (IN); Rahul Agrawal, Pune (IN)

(73) Assignee: MASTERCARD INTERNATIONAL INCORPORATED, Purchase, NY (US)

(21) Appl. No.: 16/822,326

(22) Filed: Mar. 18, 2020

(30) Foreign Application Priority Data
Mar. 18, 2019 (SG) 10201902403U

(51) Int. Cl. G06Q 40/02; G06Q 20/22; G06Q 50/00; G06F 16/901

(52) U.S. Cl. CPC G06Q 40/02; G06F 16/9024; G06Q 50/01; G06Q 20/223

(57) ABSTRACT

A method for facilitating peer-to-peer payments includes receiving, by a server, a payment request initiated by a payer for making a payment of an amount to a payee. The payment request includes social identifiers of the payer and the payee. Based on the social identifiers, the server retrieves a set of links or social graphs of the payer and payee. Based on the set of links or the social graphs, the server determines a first link that is indicative of a set of intermediaries connecting the payer and the payee. The server facilitates the transfer of the amount from a first financial account of the payer to a second financial account of the payee by a way of a set of intermediary financial accounts of the set of intermediaries indicated by the first link.

### FIELD OF THE INVENTION

The present invention relates to the field of electronic transactions and, more particularly, to a method and a system for facilitating peer-to-peer (P2P) payments.

### BACKGROUND

Technological advancements have allowed payers to make P2P payments by way of a multitude of payment modes such as debit cards, credit cards, netbanking, or digital wallets such as mobile wallets. Such payment modes have enhanced ease and comfort of the payers in performing the P2P payments.

Typically, a payer accesses a service application (such as a banking application or a wallet application) on a payer device to make an online P2P payment to a payee. For making the P2P payment, the payer is required to enter payment credentials (for example, an account number of the payee's financial account, a contact number of the payee, or the like) of the payee in the service application. However, in certain scenarios, the payer may not know the payment credentials of the payee and/or may face difficulties in acquiring the payment credentials. Such a scenario inconveniences both the payer and the payee. Further, the service application may not support all available payment modes. Thus, the payer may be unable to make the P2P payment when a payment mode that the payer wants to use is not supported by the service application. For example, the payer may want to use a digital wallet for making the P2P payment and the service application may not support payments via digital wallets. Consequently, the payer may be inconvenienced by a lack of options provided by the service application, in regards to payment modes.

In light of the foregoing, there exists a need for a technical solution that allows a payer to make a P2P payment to a payee without requiring payment credentials of the payee. Further, the technical solution needs to allow the payer to make the P2P payment by way of a payment mode preferred by the payer.

### SUMMARY

In an embodiment of the present invention, a method for facilitating peer-to-peer (P2P) payments is provided. The method includes receiving, by a server from a payer device, a payment request initiated by a payer for making a payment of a first amount to a payee. The payment request includes first and second identifiers of the payer and the payee, respectively. The server retrieves, from a social platform, a set of links between the payer and payee based on the first and second identifiers. Each link of the set of links is indicative of a set of intermediaries that connects the payer to the payee on the social platform. The server selects, from the set of links, a first link indicative of a first set of intermediaries. The server processes the payment request by facilitating a transfer of the first amount from a first financial account of the payer to a second financial account of the payee by way of a first set of financial accounts of the first set of intermediaries.

In another embodiment of the present invention, a system for facilitating P2P payments is provided. The system includes a payment network server that is configured to receive, from a payer device, a payment request initiated by a payer by way of the service application. The payment request is for making a payment of a first amount to a payee. The payment request includes first and second identifiers of the payer and payee, respectively. The payment network server retrieves, from a social platform, a set of links between the payer and payee based on the first and second identifiers, such that each link of the set of links is indicative of a set of intermediaries that connects the payer to the payee on the social platform. The payment network server selects a first link indicative of a first set of intermediaries from the set of links. The payment network server processes the payment request by facilitating a transfer of the first amount from a first financial account of the payer to a second financial account of the payee by way of a first set of financial accounts of the first set of intermediaries.

In yet another embodiment of the present invention, a method for facilitating P2P payments is provided. The method includes receiving, by a server from a payer device, a payment request initiated by a payer for making a payment of a first amount to a payee. The payment request includes first and second identifiers of the payer and payee, respectively. The server receives, from at least first and second social platforms, first and second social graphs of the payer and payee based on the first and second identifiers, respectively. The server determines, based on the first and second social graphs, a link connecting the payer and payee. The link is indicative of a set of intermediaries that connects the payer and payee. The server processes the payment request by facilitating a transfer of the first amount from a first financial account of the payer to a second financial account of the payee by way of a set of financial accounts of the set of intermediaries.

### BRIEF DESCRIPTION OF THE DRAWINGS

Various embodiments of the present invention are illustrated by way of example, and not limited by the appended figures, in which like references indicate similar elements, and in which:

FIG. 1 is a block diagram that illustrates an exemplary environment for facilitating peer-to-peer (P2P) payments, in accordance with an embodiment of the present invention;

FIG. 2 represents a process flow diagram that illustrates an exemplary scenario for enrolling a customer of FIG. 1 for a P2P payment service offered by a payment network of FIG. 1, in accordance with an embodiment of the present invention;

FIG. 3 represents a process flow diagram that illustrates an exemplary scenario for registering a customer as an intermediary for the P2P payment service, in accordance with an embodiment of the present invention;

FIGS. 4A-4C, collectively represent a process flow diagram that illustrates an exemplary scenario for facilitating a P2P payment, in accordance with an embodiment of the present invention;

FIG. 4D represents a process flow diagram that illustrates an exemplary scenario for facilitating a P2P payment, in accordance with another embodiment of the present invention;

FIGS. 5A and 5B represent a block diagram that illustrates an exemplary scenario for selecting an optimal link for facilitating the P2P payment, in accordance with an embodiment of the present invention;

FIGS. 6A-6C, collectively represent a process flow diagram that illustrates another exemplary scenario for facilitating a P2P payment, in accordance with another embodiment of the present invention;

FIG. 7A is a block diagram that illustrates a first social graph generated by a first social platform server of FIG. 1, in accordance with an embodiment of the present invention;

FIG. 7B is a block diagram that illustrates a second social graph generated by a second social platform server of FIG. 1, in accordance with an embodiment of the present invention;

FIG. 7C is a block diagram that illustrates a merged social graph generated by the payment network server of FIG. 1, in accordance with an embodiment of the present invention;

FIG. 7D is a block diagram that illustrates another optimal link determined by the payment network server for facilitating the P2P payment, in accordance with another embodiment of the present invention;

FIGS. 8A and 8B represent an exemplary scenario that illustrates UI screens that are rendered on a display of a first customer device of FIG. 1, in accordance with an embodiment of the present invention;

FIGS. 9A and 9B represent an exemplary scenario that illustrates UI screens that are rendered on the display of the first customer device of FIG. 1, in accordance with another embodiment of the present invention;

FIG. 10 is a block diagram that illustrates a payment network server of FIG. 1, in accordance with an embodiment of the present invention;

FIGS. 11A and 11B, collectively represent a flow chart that illustrates a method for facilitating a P2P payment, in accordance with an embodiment of the present invention;

FIG. 12 represents a high-level flow chart that illustrates the method for facilitating P2P payments, in accordance with an embodiment of the present invention;

FIG. 13 represents a high-level flow chart that illustrates the method for facilitating P2P payments, in accordance with another embodiment of the present invention; and

FIG. 14 is a block diagram that illustrates system architecture of a computer system 1400, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the present invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### OVERVIEW

A payer may access a service application to make a payment to a payee (i.e., a payee). For making the payment to the payee, the payer requires payment credentials of the payee. However, in a scenario where the payer is not aware of the payment credentials of the payee, the payer is unable to make the payment. Further, the service application may not allow the payer to use a payment mode preferred by the payer for making the payment. Thus, both the payer and the payee are inconvenienced.

Various embodiments of the present invention provide a method and a system that solve the abovementioned problems by enabling the payer to make the payment to the payee without requiring the payment credentials of the payee. Further, the payer is allowed to make the payment using a payment mode preferred by the payer. The payer initiates the payment of a first amount to the payee by way of a service application hosted by a server, for example a payment network server. The payer may initiate the payment using any payment mode preferred by the payer. The service application generates a payment request based on the payment initiated by the payer. The payment request includes first and second identifiers (IDs) of first and second social accounts of the payer and the payee, respectively. In a first scenario, the first and second social accounts may be maintained at the same social platform. The payment request is received by the server hosting the service application. Based on the payment request, the server communicates the first and second IDs to the social platform and requests the first social platform to return a first set of links connecting the payer and the payee on the first social platform (i.e., a first set of links between the payer and the payee). The first social platform determines the first set of links and communicates the first set of links to the server. Each link of the first set of links is indicative of a set of intermediaries that connects the payer to the payee on the social platform. The server selects an optimal link from the first set of links such that each intermediary of a first set of intermediaries indicated by the optimal link is registered with the server. In a second scenario, the first and second social accounts may be maintained at two different social platforms, for example, first and second social platforms, respectively. In such a scenario, the server communicates the first and second IDs to the first and second social platforms, respectively, and requests the first and second social platforms to return first and second social graphs of the payer and the payee, respectively. The first and second social graphs are indicative of customers directly and/or indirectly connected to the payer and the payee on the first and second social platforms, respectively. The first and second social platforms communicate the first and second social graphs to the server. Based on the first and second social graphs, the server determines another optimal link that connects the payer and the payee. The optimal link includes a second set of intermediaries such that each intermediary of the second set of intermediaries is registered with the server.

The server may process the payment request by facilitating a transfer of the first amount from a first financial account of the payer to a second financial account of the payee by way of financial accounts of one of the first set of intermediaries or the second set of intermediaries. The server may notify the payer when the first amount is successfully transferred to the second financial account of the payee.

Thus, the method and system of the present invention enable the payer to make payments to the payee by using any preferred payment mode and without requiring the payment credentials of the payee.

### Terms Description (in Addition to Plain and Dictionary Meaning)

Peer-to-peer (P2P) payment is an electronic payment made by a payer to a payee, typically, by way of a service application such as, for example, a mobile application or a web application. The payer is a customer who wants to make the P2P payment and the payee is another customer who receives a payment amount from the payer. The P2P payment involves a transfer of a first amount from a first account (such as a first payment account or a first digital wallet) of the payer to a second account (such as a second payment account or a second digital wallet) of the payee. Hereinafter, the terms ‘P2P payment’ and ‘payment’ have been interchangeably used.

Service application is an application accessible to a customer on a customer device. The service application allows the customer to make P2P payments to other customers. The service application may be a mobile application running on the customer device or a web application accessible through a browser installed on the customer device. The service application may be hosted by an issuer or a payment network.

Payment request is a request generated by a payer for making a P2P payment to a payee. The payment request includes identifiers (IDs) of the payer and payees, a payment amount of the P2P payment, or the like. In one embodiment, the payment request is initiated by way of a service application running on a payer device of the payer.

First and second IDs are identifiers that uniquely identify social accounts of a payer and a payee, respectively, on a social platform. The First and second IDs may include, but are not limited to, a username, a contact number (such as a phone number) linked to the social account, a social link associated with the social account, or the like.

A link is a data structure that indicates a manner in which first and second social accounts of a payer and payee, respectively, are connected on a first social platform or on first and second social platforms. The link may be indicative of a set of intermediaries that connect the payer and the payee. Each intermediary serves as a facilitator of a P2P payment between the payer and the payee.

Social graph is data structure generated by a social platform to indicate customers that are directly or indirectly connected to a first customer (for example, a payer or a payee) on the social platform. In other words, the social graph indicates social accounts that are directly or indirectly connected to a first social account of the first customer on the social platform.

Financial accounts are accounts (such as payment accounts or digital wallets) maintained by payers, payees, and/or intermediaries at one or more issuers. The financial accounts are used by the payers, the payees, and/or the intermediaries to make financial transactions (such as P2P payments).

Issuer is a financial institution which establishes and maintains payment accounts of several customers. The issuer authorizes and settles transactions in accordance with various payment network regulations and local legislation.

Payment networks, such as those operated by Mastercard®, process transactions between acquirers and issuers. Processing by a payment network includes steps of authorization, clearing, and settlement.

Server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of an acquirer server, a payment network server, or an issuer server.

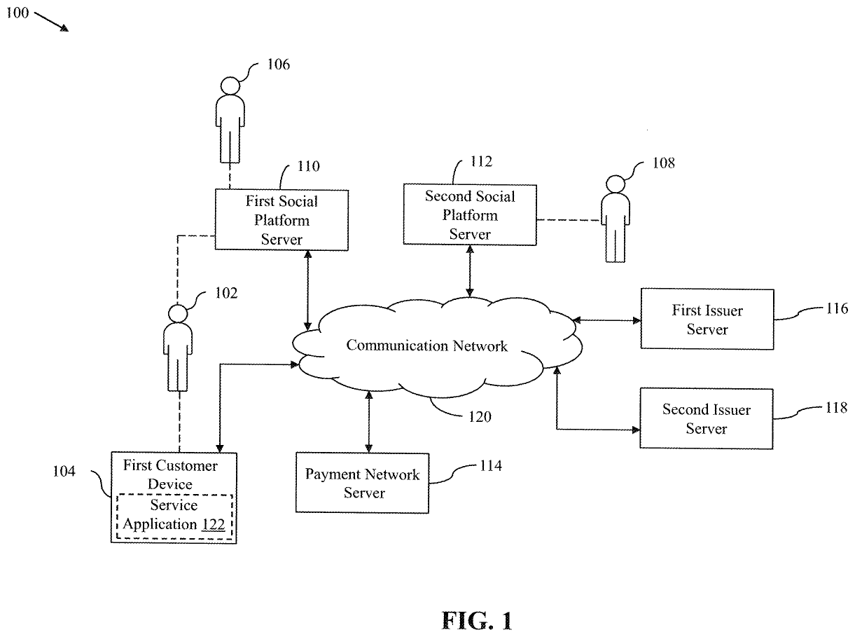

FIG. 1 is a block diagram that illustrates an exemplary environment 100 for facilitating P2P payments, in accordance with an embodiment of the present invention. The environment 100 includes a first customer 102 in possession of a first customer device 104. The environment 100 further includes a second customer 106, a third customer 108, a first social platform server 110, a second social platform server 112, a payment network server 114, a first issuer server 116, and a second issuer server 118. The first customer device 104, the first social platform server 110, the second social platform server 112, the payment network server 114, the first issuer server 116, and the second issuer server 118 may communicate with each other by way of a communication network 120 or through separate communication networks established therebetween.

The first customer 102 is an individual, who is an account holder of various financial accounts, such as a first payment account and/or a first digital wallet. The first payment account and the first digital wallet may be maintained at a financial institution, such as a first issuer. Examples of the first digital wallet include, but are not limited to, Apple Pay Cash®, PayPal®, or the like. The first issuer may have issued a first transaction card (e.g., a debit card, a credit card, or the like) linked to the first payment account to the first customer 102. The first transaction card may be a physical card or a virtual card stored in a memory of the first customer device 104. The first customer 102 may have created a first social account having a first social link on a first social platform. The first social link may uniquely identify the first social account. The first customer 102 may login to the first social account by using login credentials (e.g., a username and a password) linked to the first social account. Examples of the first social platform may include, but are not limited to, Facebook®, LinkedIn®, Instagram®, or the like.

The first customer device 104 (i.e., a payer device) is a communication device of the first customer 102 and includes suitable logic, circuitry, interfaces, and/or codes, executable by the circuitry that performs one or more operations for facilitating P2P payments. The first customer device 104 is used by the first customer 102 to access a service application 122. The service application 122 may be a mobile application or a web application that runs on the first customer device 104 and is hosted by a financial institution (such as an issuer or a payment network). In a non-limiting example, it is assumed that the payment network server 114 hosts the service application 122. The service application 122 allows the first customer 102 to initiate the P2P payments and other types of financial transactions, such as purchases, funds transfers, or the like. Examples of the first customer device 104 include a smartphone, a personal computer, a tablet, a phablet, or the like.

The second customer 106 is an individual, who is an account holder of various financial accounts, such as a second payment account and/or a second digital wallet. The second payment account and the second digital wallet may be maintained at a financial institution, such as the first issuer or an issuer different from the first issuer. In a non-limiting example, it is assumed that the second payment account and the second digital wallet are maintained at the first issuer. The second customer 106 may have created a second social account having a second social link on the first social platform. The second social link may uniquely identify the second social account. The second customer 106 may login to the second social account by using login credentials (e.g., a username and a password) linked to the second social account.

The third customer 108 is an individual, who is an account holder of various financial accounts such as a third payment account and/or a third digital wallet. The third payment account and the third digital wallet may be maintained at a financial institution, such as the first issuer or an issuer different from the first issuer. In a non-limiting example, it is assumed that the third payment account and the third digital wallet are maintained at the first issuer. The third customer 108 may have created a third social account having a third social link on a second social platform that is different from the first social platform, where the first and second customers 102 and 106 have created the first and second social accounts, respectively. The third social link may uniquely identify the third social account. The third customer 108 may login to the third social account by using login credentials (e.g., a username and a password) linked to the third social account.

The first social platform server 110 is a computing server that hosts the first social platform. The first social platform server 110 maintains social accounts created on the first social platform. For example, the first social platform server 110 maintains the first and second social accounts of the first and second customers 102 and 106. Each social account may be linked to a name, a contact number, and an e-mail ID of a corresponding account holder and a social link. For example, the first social account is linked to the name, the contact number, and the e-mail ID of the first customer 102 and the first social link (e.g., ‘JaneDoe@abc.com’). Likewise, the second social account is linked to the name, the contact number, and the e-mail ID of the second customer 106 and the second social link (e.g., ‘JohnDoe@abc.com’). The first social platform server 110 may maintain data structures (i.e., social graphs) that indicate connections of each social account with other social accounts created on the first social platform.

The second social platform server 112 is a computing server that hosts the second social platform. The second social platform server 112 maintains social accounts created on the second social platform. For example, the second social platform server 112 maintains the third social account of the third customer 108. Similar to the first and second social accounts, the third social account may be linked to the name, the contact number, and the e-mail ID of the third customer 108 and the third social link (e.g., ‘SamDoe@abc.com’). The second social platform server 112 may maintain data structures (i.e., social graphs) that indicate connections of each social account with other social accounts created on the second social platform.

The payment network server 114 is a computing server that is operated by the payment network. The payment network is an intermediate entity between acquirers and issuers for processing transactions. In one embodiment, the payment network server 114 hosts the service application 122 for offering a P2P payment service. The P2P payment service offered by the service application 122 allows a customer (e.g., the first customer 102) to make a P2P payment to another customer even when payment credentials (for example, bank account number, contact number, digital wallet ID, or the like) of the other customer are not available with the first customer 102.

The service application 122 is executable on various customer devices (e.g., the first customer device 104) for making P2P payments. For example, the service application 122 allows the first customer 102 to initiate a payment request for making a payment of a first amount to a payee (e.g., the second customer 106 or the third customer 108). For initiating the payment request, the first customer 102 is required to provide a first social ID (e.g., the first social link or the e-mail ID) associated with the first social account and another social ID associated with a social account of the payee. In one embodiment, the social account of the payee may be maintained at the first social platform where the first social account of the first customer 102 is maintained. In another embodiment, the social account of the payee may be maintained at the second social platform.

The payment network server 114 receives the payment request initiated by the first customer 102. Based on the payment request, the payment network server 114 selects or determines an optimal link between the first customer 102 and the payee. The optimal link may be indicative of one or more intermediaries that connect the first customer 102 to the payee. The payment network server 114 then facilitates a transfer of the first amount from the first payment account or the first digital wallet of the first customer 102 to a payment account or a digital wallet of the payee by way of payment accounts or digital wallets of the intermediaries indicated by the optimal link.

The first issuer server 116 is a computing server that is operated by the first issuer. The first issuer may be a financial institution that manages payment accounts and/or digital wallets (e.g., the first payment account and the first digital wallet) of multiple customers (e.g., the first customer 102, the second customer 106, and/or the third customer 108). Account details of the payment accounts and digital wallets established with the first issuer are stored as account profiles. The first issuer server 116 credits and debits the payment accounts and the digital wallets based on transactions performed by the customers (such as the first customer 102) from the corresponding accounts.

The second issuer server 118 is a computing server that is operated by a second issuer that is different from the first issuer. The second issuer is a partner issuer of the payment network and maintains a fourth payment account of the payment network. It will be apparent to those of skill in the art that the second issuer server 118 is functionally similar to the first issuer server 116.

The communication network 120 is a medium through which content and messages are transmitted between the first customer device 104, the first and second social platform servers 110 and 112, the payment network server 114, the first and second issuer servers 116 and 118, and other entities that are pursuant to one or more standards for the interchange of transaction messages, such as the ISO8583 standard. Examples of the communication network 120 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 120 in accordance with various wired and wireless communication protocols, such as Transmission Control Protocol and Internet Protocol (TCP/IP), User Datagram Protocol (UDP), Long Term Evolution (LTE) communication protocols, or any combination thereof.

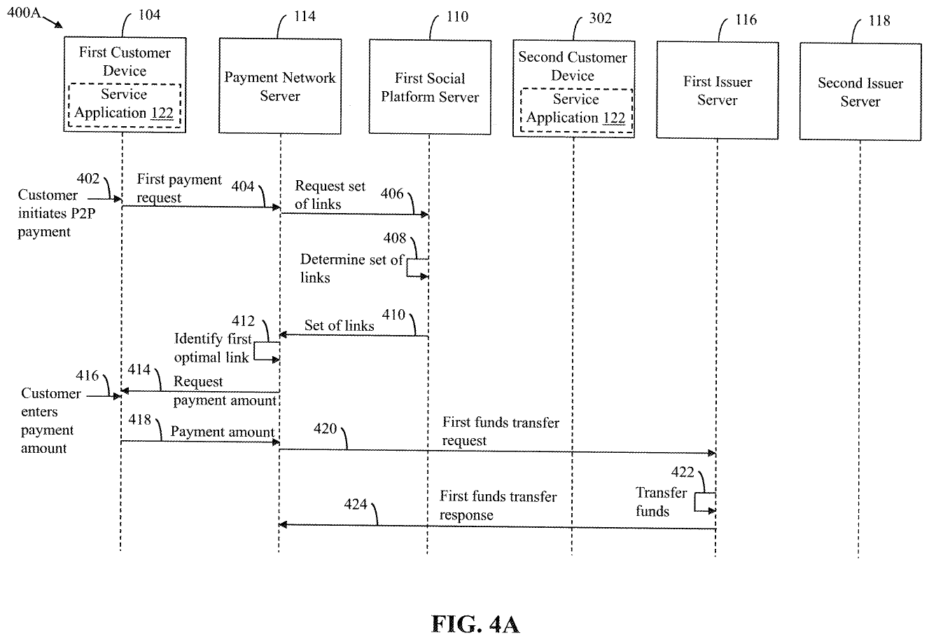

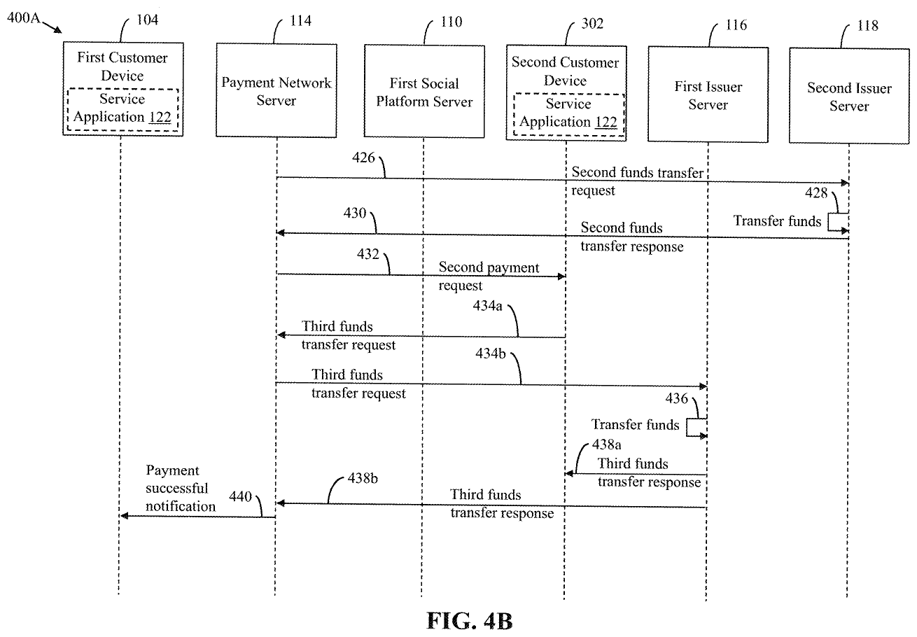

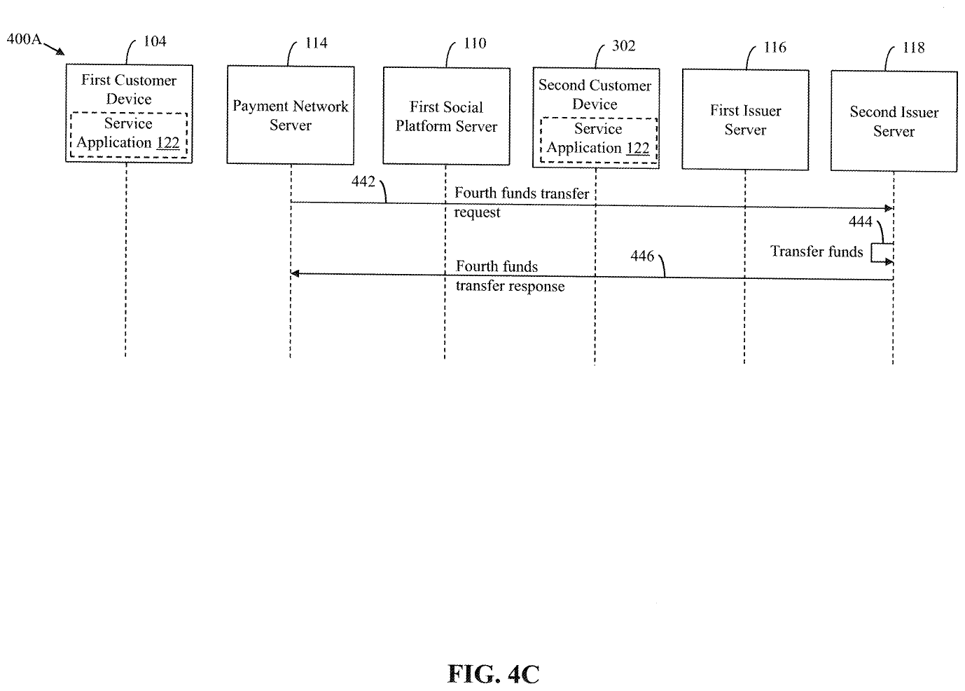

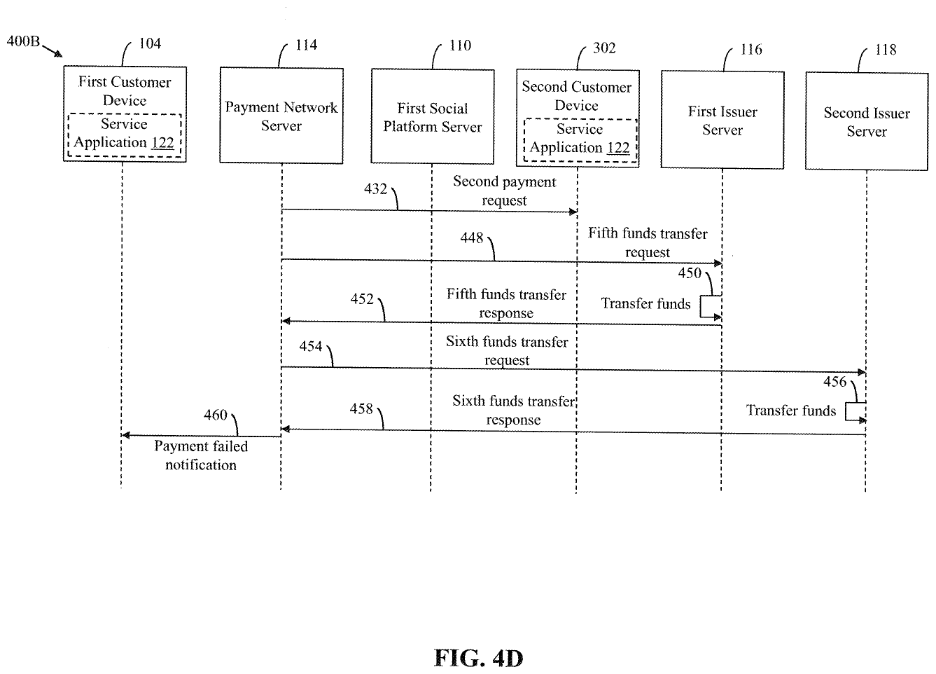

In operation, the first customer 102 (i.e., the payer) may want to make a payment of the first amount to the second customer 106 (i.e., the payee). The first customer device 104 is utilized by the first customer 102 to access the service application 122. The first customer 102 provides the first social ID (e.g., the first social link) of the first social account and the second social ID (e.g., the second social link) of the second social account of the second customer 106 to the service application 122. The service application 122 generates a payment request. The payment request includes information regarding the first and second social IDs provided by the first customer 102 and the first amount. The payment request is received by the payment network server 114. Based on the payment request, the payment network server 114 determines that both the first and second social accounts associated with the first and second social IDs, respectively, are maintained at the first social platform server 110. Thus, the payment network server 114 requests the first social platform server 110 to determine a first set of links between the first customer 102 and the second customer 106 on the first social platform. In other words, the first set of links connects the first customer 102 to the second customer 106 on the first social platform. The first social platform server 110 determines the first set of links that connects the first and second customers 102 and 106 on the first social platform. Each link in the first set of links is indicative of a set of customers that have social accounts on the first social platform. The first social platform server 110 communicates the first set of links to the payment network server 114. The payment network server 114 selects a first optimal link from the first set of links, such that each customer indicated by the first optimal link is registered with the payment network server 114 as an intermediary for using the service application 122. After identifying the first optimal link, the payment network server 114 processes the payment request for transferring the first amount from the first payment account or the first digital wallet of the first customer 102 to the second payment account or the second digital wallet of the second customer 106 by way of payment accounts or digital wallets of the intermediaries indicated by the first optimal link. Process of transferring the first amount from the first payment account or the first digital wallet of the first customer 102 to the second payment account or the second digital wallet of the second customer 106 is explained in conjunction with FIGS. 4A-4C.

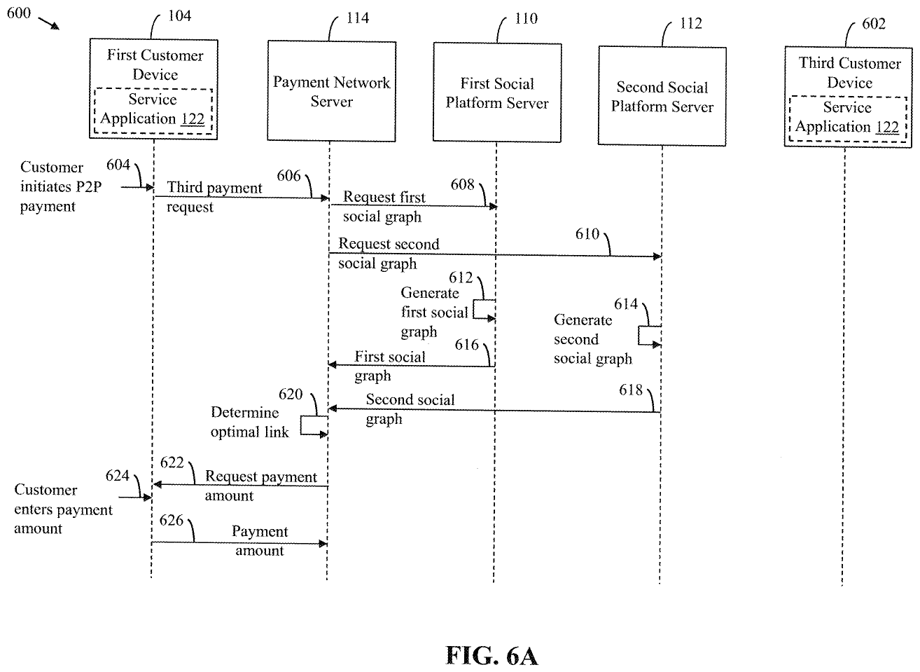

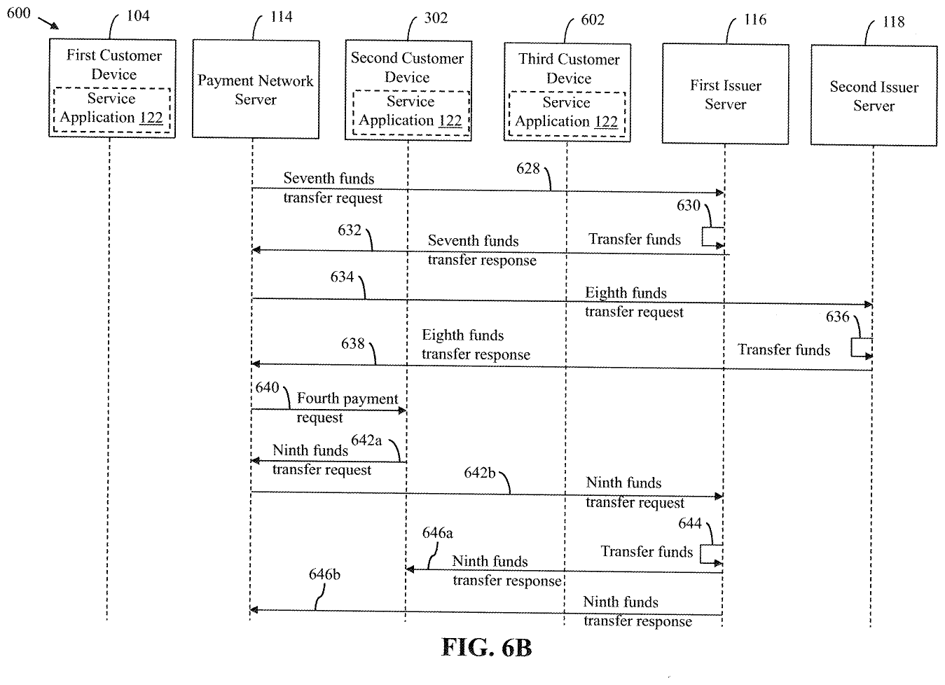

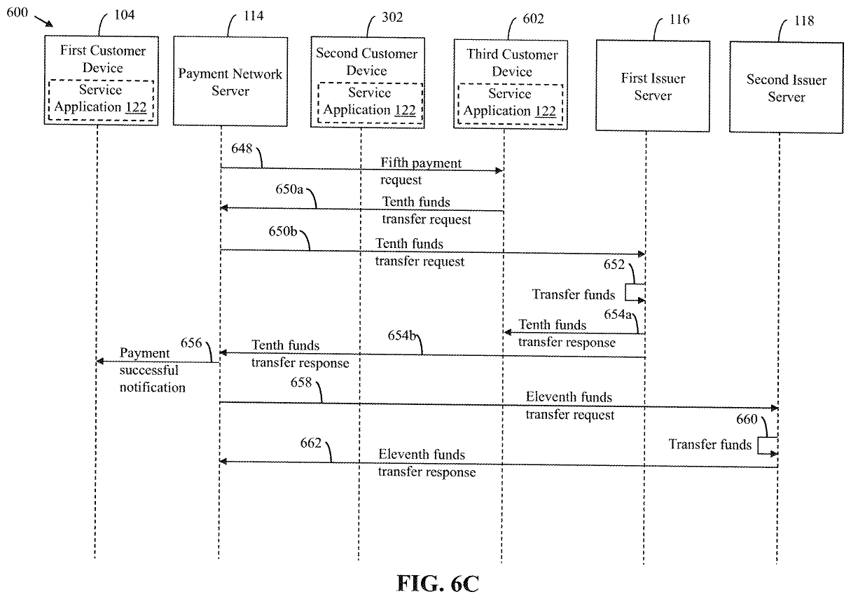

In another embodiment, the first customer 102 (i.e., the payer) may want to make the payment of the first amount to the third customer 108 (i.e., the payee). Thus, the first customer 102 provides the first social ID associated with the first social account and a third social ID (e.g., the third social link) associated with the third social account of the third customer 108 to the service application 122. The service application 122 communicates another payment request to the payment network server 114. The payment request includes information regarding the first and third social IDs and the first amount. Based on the payment request, the payment network server 114 determines that the first and third social accounts linked to the first and third social IDs, respectively, are maintained at different social platform servers, i.e., the first and second social platform servers 110 and 112, respectively. Thus, the payment network server 114 requests the first and second social platform servers 110 and 112 to provide first and second social graphs associated with the first and third social accounts, respectively. The first and second social platform servers 110 and 112 communicate the first and second social graphs, respectively, to the payment network server 114. Based on the first and second social graphs, the payment network server 114 determines a second optimal link that connects the first and third customers 102 and 108 on the first and second social platforms. The second optimal link is indicative of one or more customers that are registered with the payment network server 114 as intermediaries for using the service application 122. After determining the second optimal link, the payment network server 114 processes the payment request for transferring the first amount from the first payment account or the first digital wallet of the first customer 102 to the third payment account or the third digital wallet of the third customer 108 by way of payment accounts or digital wallets of the intermediaries indicated by the second optimal link. Process of transferring the first amount from the first payment account or the first digital wallet of the first customer 102 to the third payment account or the third digital wallet of the third customer 108 is explained in conjunction with FIGS. 6A-6C.

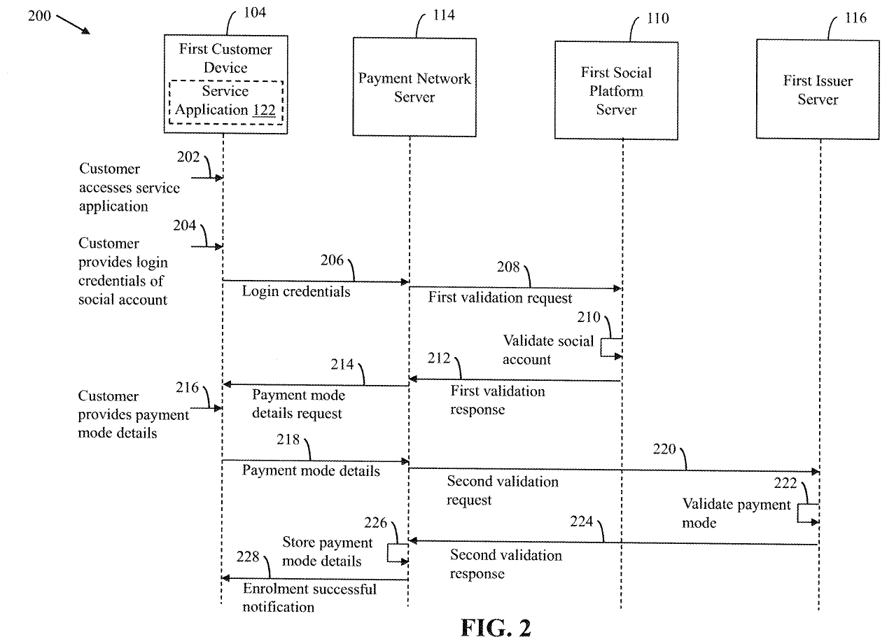

FIG. 2 represents a process flow diagram 200 that illustrates an exemplary scenario for enrolling the first customer 102 for the P2P payment service offered by the payment network server 114, in accordance with an embodiment of the present invention. The process flow diagram 200 involves the first customer device 104, the first social platform server 110, the payment network server 114, the first issuer server 116, and the service application 122.

The first customer 102 accesses the service application 122 on the first customer device 104 (as shown by arrow 202). The first customer 102 then logs into the service application 122 by providing authentication information of the first customer 102 to the service application 122. Examples of authentication information may include a username and password, a one-time password (OTP), or the like. After the first customer 102 has successfully logged in, the service application 122 may present, on a user interface (UI) of the service application 122, a first option that allows the first customer 102 to enroll for the P2P payment service for making P2P payments. When the first customer 102 selects the first option, the service application 122 prompts the first customer 102 to provide login credentials of a social account that belongs to the first customer 102. The first customer 102, thus, provides the login credentials of the first social account to the service application 122 (as shown by arrow 204). The first customer device 104 communicates the login credentials, provided by the first customer 102, to the payment network server 114 (as shown by arrow 206). For ensuring data security of the login credentials the first customer 102, the payment network server 114 may not store the login credentials provided by the first customer 102. Based on the login credentials, the payment network server 114 identifies that the first social account is maintained at the first social platform. Thus, the payment network server 114 transmits a first validation request to the first social platform server 110 (as shown by arrow 208), requesting the first social platform server 110 to validate the first social account. The first validation request includes the login credentials of the first social account. The first social platform server 110 validates the first social account based on the first validation request (as shown by arrow 210).

The first social platform server 110 transmits a first validation response to the payment network server 114 (as shown by arrow 212). The first validation response indicates whether the first social account is valid or invalid. In a non-limiting example, it is assumed that the first social account is valid. On receiving the first validation response, the payment network server 114 requests, by way of the service application 122, the first customer 102 to provide details of one or more payment modes that the first customer 102 wants to add to the service application 122 (as shown by arrow 214). In one embodiment, the first customer 102 may provide transaction card details (hereinafter, ‘first transaction card details’) of the first transaction card to the service application 122 (as shown by arrow 216). The first transaction card details may include a first transaction card number, a first expiry date of the first transaction card, or the like. The first customer device 104 transmits the first transaction card details (i.e., the payment mode details) to the payment network server 114 (as shown by arrow 218). The payment network server 114 identifies that the first issuer server 116 corresponds to the first transaction card (i.e., the payment mode). Thus, the payment network server 114 transmits a second validation request to the first issuer server 116, requesting the first issuer server 116 to validate the first transaction card (as shown by arrow 220). The second validation request includes the first transaction card details. The first issuer server 116 validates the first transaction card (as shown by arrow 222) using various methods and techniques known in the art. The first issuer server 116 transmits, to the payment network server 114, a second validation response that indicates whether the first transaction card is valid (as shown by arrow 224). In a non-limiting example, it is assumed that the second validation response indicates that the first transaction card is valid. Based on the second validation response, the payment network server 114 stores the first transaction card details in a memory of the payment network server 114 (as shown by arrow 226). Thus, the first transaction card is added on the service application 122 as a saved payment mode and the first customer 102 is allowed to use the first transaction card for making any transaction by way of the service application 122. It will be apparent to those of skill in the art that the first customer 102 may add other payment modes, such as the first payment account, the first digital wallet, or the like, to the service application 122. The payment network server 114 transmits, to the first customer device 104 by way of the service application 122, a first notification that indicates successful enrollment of the first customer 102 for the P2P payment service (as shown by arrow 228).

In one embodiment, the first customer 102 may choose one of the added payment modes as a default payment mode. In a non-limiting example, it is assumed that the first customer 102 chooses the first transaction card as the default payment mode. In another embodiment, the first customer 102 may provide login credentials of multiple social accounts that belong the first customer 102. In such a scenario, the payment network server 114 transmits validation requests to all social platforms for which the first customer 102 has provided the login credentials.

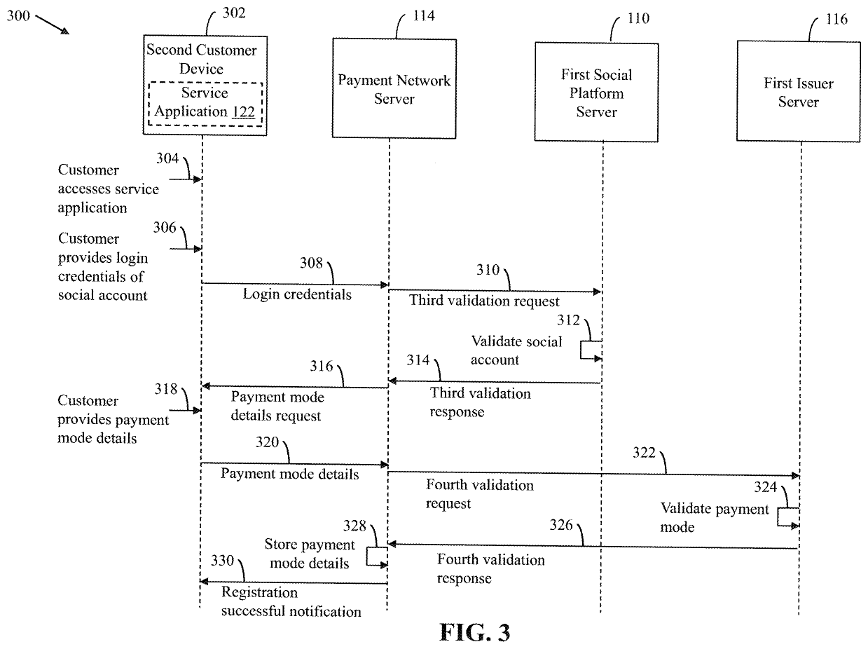

FIG. 3 represents a process flow diagram 300 that illustrates an exemplary scenario for registering a customer as an intermediary for the P2P payment service, in accordance with an embodiment of the present invention. The process flow diagram 300 involves a second customer device 302 of a fourth customer (not shown), the first social platform server 110, the payment network server 114, the first issuer server 116, and the service application 122. It is assumed that the second customer device 302 is functionally similar to the first customer device 104 and that the fourth customer accesses the service application 122 on the second customer device 302. For the sake of simplicity and without limiting the scope of the invention, it is assumed that the fourth customer is an account holder of a fifth payment account maintained at the first issuer.

The fourth customer accesses the service application 122 on the second customer device 302 (as shown by arrow 304). The fourth customer then logs into the service application 122 by providing corresponding authentication information to the service application 122. Examples of authentication information may include a username and password, an OTP, or the like. After the fourth customer has successfully logged in, the service application 122 may present, on the UI of the service application 122, a second option that allows the fourth customer to register as an intermediary for the P2P payment service. When the first customer 102 selects the second option, the service application 122 prompts the fourth customer to provide login credentials of a social account that belongs to the fourth customer. The fourth customer, thus, provides the login credentials of a fourth social account of the fourth customer to the service application 122 (as shown by arrow 306). In a non-limiting example, it is assumed that the fourth social account is maintained at the first social platform. The first customer device 104 communicates the login credentials, provided by the fourth customer, to the payment network server 114 (as shown by arrow 308). For ensuring data security of the login credentials the fourth customer, the payment network server 114 may not store the login credentials provided by the fourth customer. Based on the login credentials, the payment network server 114 identifies that the fourth social account is maintained at the first social platform. Thus, the payment network server 114 transmits a third validation request to the first social platform server 110 (as shown by arrow 310), requesting the first social platform server 110 to validate the fourth social account. The first validation request includes the login credentials of the fourth social account. The first social platform server 110 validates the fourth social account based on the first validation request (as shown by arrow 312).

The first social platform server 110 transmits a third validation response to the payment network server 114 (as shown by arrow 314). The third validation response indicates whether the fourth social account is valid. In a non-limiting example, it is assumed that the fourth social account is valid. On receiving the third validation response, the payment network server 114 requests, by way of the service application 122, the fourth customer to provide details of one or more payment modes that the fourth customer wants to add to the service application 122 (as shown by arrow 316). In a non-limiting example, the fourth customer intends to add netbanking as a payment mode. So, the fourth customer provides details of the fifth payment account to the service application 122 (as shown by arrow 318). The details of the fifth payment account may include an account number of the fifth payment account, a name of the issuer, a name of the fourth customer, or the like. The first customer device 104 transmits the details of the fifth payment account to the payment network server 114 (as shown by arrow 320). Based on the details of the fifth payment account, the payment network server 114 identifies that the first issuer server 116 corresponds to the fifth payment account. Thus, the payment network server 114 transmits a fourth validation request to the first issuer server 116, requesting the first issuer server 116 to validate the fifth payment account (as shown by arrow 322). The fourth validation request includes the details of the fifth payment account.

The first issuer server 116 validates the fifth payment account (as shown by arrow 324) using various methods and techniques known in the art. The first issuer server 116 transmits, to the payment network server 114, a fourth validation response that indicates whether the fifth payment account is valid (as shown by arrow 326). In a non-limiting example, it is assumed that the fourth validation response indicates that the fifth payment account is valid. Based on the fourth validation response, the payment network server 114 stores the details of the fifth payment account in the memory of the payment network server 114 (as shown by arrow 328). Thus, fifth payment account is added on the service application 122 as a saved payment mode and the fourth customer is allowed to use the fifth payment account (i.e., netbanking) for making any transaction by way of the service application 122. It will be apparent to those of skill in the art that the fourth customer may add other payment modes, such as transaction cards, digital wallets, or the like, to the service application 122. The payment network server 114 transmits, to the fourth customer device 302 by way of the service application 122, a second notification that indicates successful registration of the fourth customer as intermediary for the P2P payment service (as shown by arrow 330).

In one embodiment, the fourth customer may choose one of the added payment modes as a default payment mode. In a non-limiting example, it is assumed that the fourth customer chooses the fifth payment account as the default payment mode.

In one embodiment, the service application 122 may present a third option to a customer who has already enrolled for the P2P payment service. The third option allows an already enrolled customer to register as an intermediary for the P2P payment service. When the third option is selected by the already enrolled customer, the payment network server 114 may not need to validate the social account of the customer as the social account was already validated at the time of enrollment.

FIGS. 4A-4C, collectively represent a process flow diagram 400A that illustrates an exemplary scenario for facilitating a P2P payment, in accordance with an embodiment of the present invention. The process flow diagram 400A involves the first customer device 104, the first social platform server 110, the payment network server 114, the first issuer server 116, the second issuer server 118, the service application 122, and the second customer device 302. In a non-limiting example, it is assumed that the first customer 102 (i.e., the payer) has already enrolled for availing the P2P payment service and wants to make a P2P payment to the second customer 106 (i.e., the payee) who may not be enrolled for the P2P payment service.

For making the P2P payment to the second customer 106, the first customer 102 accesses the service application 122 on the first customer device 104 and logs into the service application 122. The first customer device 104 presents a UI of the service application 122 thereon to allow the first customer 102 to initiate the P2P payment. By way of the UI, the first customer 102 is prompted to enter a social ID of a social account that belongs to the first customer 102 and another social ID of a social account that belongs to the second customer 106. The first customer 102 enters the first and second social IDs (e.g., the first and second social links) associated with the first and second social accounts, respectively, in the UI for initiating the P2P payment (as shown by arrow 402). The second social account belongs to the second customer 106, as described in FIG. 1.

The service application 122 generates a first payment request for the P2P payment. The first payment request includes the first and second social IDs. The first customer device 104 communicates the first payment request to the payment network server 114 (as shown by arrow 404). Based on the first and second social IDs included in the first payment request, the payment network server 114 determines that the first and second social accounts are maintained at the same social platform, i.e., the first social platform. Thus, the payment network server 114 communicates the first and second social IDs to the first social platform server 110 for requesting the first social platform server 110 to determine links between the first and second customers 102 and 106, such that the links connect the first and second customers 102 and 106 on the first social platform (as shown by arrow 406).

The first social platform server 110 identifies the first and second social accounts based on the first and second social IDs, respectively. The first social platform server 110 determines a first set of links that connects the first and second social accounts on the first social platform (as shown by arrow 408). Each link in the first set of links is indicative of a first set of social accounts, corresponding to a first set of customers, by way of which the first and second social accounts are connected to each other on the first social platform. For example, a first link in the first set of links may include social account details of two customers such that the two customers indicated by the first link are directly connected to each other on the first social platform. The first customer 102 is directly connected to one of the two customers on the first social platform and the second customer 106 is directly connected to the other customer on the first social platform. In other words, the two customers represented by the first link indirectly connect the first and second customers 102 and 106 on the first social platform. The first set of links includes multiple links similar to the first link. The first social platform server 110 transmits the first set of links to the payment network server 114 (as shown by arrow 410).

Based on the first set of links, the payment network server 114 identifies those customers, from the first set of customers, who are not registered as intermediaries for the P2P payment service. The payment network server 114 discards, from the first set of links, those links that include any customer not registered as an intermediary for the P2P payment service. Consequently, the payment network server 114 determines a first subset of the first set of links which only includes customers that are registered as intermediaries for the P2P payment service.

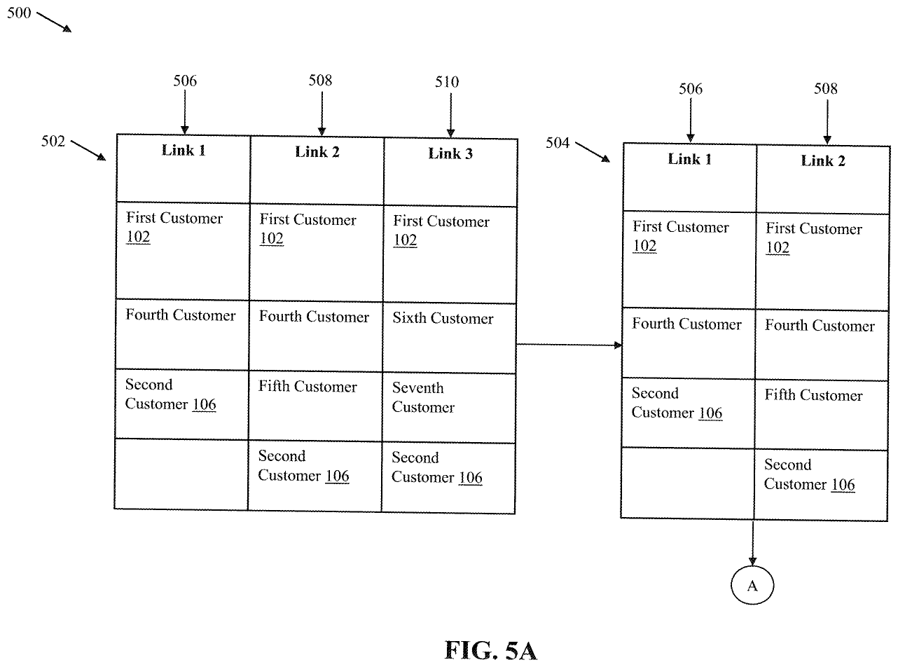

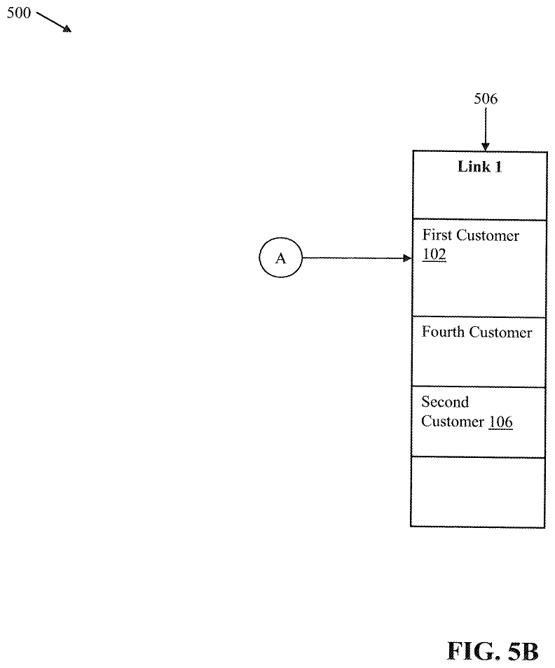

From the first subset of links, the payment network server 114 selects a first optimal link (as shown by arrow 412). In one example, the first optimal link is a link in the first subset of links that is associated with a least count of intermediaries. For example, if the first subset of links includes two links that are associated with one and two intermediaries, respectively, the payment network server 114 may select the link that is associated with one intermediary as the first optimal link. In a non-limiting example, it is assumed that the first optimal link selected by the payment network server 114 is associated with a single intermediary, for example, the fourth customer (hereinafter, the fourth customer is referred to as ‘first intermediary’) who has the second customer device 302 (hereinafter, the second customer device 302 is referred to as ‘first intermediary device 302’). Thus, the selected first optimal link is indicative of the fourth social account of the first intermediary. It will be apparent to those of skill in the art that the scope of the first optimal link is not limited to be associated with a single intermediary. Selection process of the first optimal link is explained in detail in conjunction with FIGS. 5A-5B.

After the first optimal link is selected, the payment network server 114 requests the first customer 102 to provide a payment amount for which the P2P payment is to be made (as shown by arrow 414). In one embodiment, the payment network server 114 may charge the first customer 102 a service fee for providing the P2P payment service. The payment network server 114 may request, by way of the service application 122, the first customer 102 to provide a consent for paying the service fee. For the sake of simplicity, it is assumed that the service fee is fixed and equal to ‘$5’. In another embodiment, the service fee may be a percentage of the payment amount. In yet another embodiment, the service fee may be determined based on a number of intermediaries involved in the P2P payment.

The first customer 102 enters the payment amount (say, ‘$100’) in the service application 122 (as shown by arrow 416) and provides consent to pay the service fee (i.e., ‘$5’). The service application 122 may also prompt the first customer 102 to select a payment mode for making the P2P payment. In a non-limiting example, it is assumed that the first customer 102 selects the first transaction card as the payment mode. However, it will be apparent to those of skill in the art that the first customer 102 may opt for any payment mode (such as the first digital wallet or the first payment account) that is added to the service application 122. In another embodiment, the service application 122 may allow the first customer 102 to add a new payment mode to the service application 122 in real time, i.e., at the time of performing the P2P payment, without deviating from the scope of the invention.

The first customer device 104 communicates information pertaining to the payment amount and the selected payment mode to the payment network server 114 (as shown by arrow 418). The payment network server 114 communicates a first funds transfer request to the first issuer server 116 (as shown by arrow 420). The first funds transfer request is a debit request and includes the card details of the first transaction card, the information pertaining to the payment amount and the service fee, and details of the fourth payment account of the payment network that is maintained at the second issuer server 118.

In a non-limiting example, it is assumed that first issuer server 116 debits the payment amount and the service fee (i.e., a total of ‘$105’) from the first payment account associated with the first transaction card and credits to the fourth payment account based on the first funds transfer request (as shown by arrow 422). The first issuer server 116 transmits a first funds transfer response to the payment network server 114, indicating that the payment amount and the service fee have been successfully transferred to the fourth payment account (as shown by arrow 424).

Based on the first funds transfer response, the payment network server 114 communicates a second funds transfer request to the second issuer server 118, requesting the second issuer server 118 to transfer the payment amount (e.g., ‘$100’) to the fifth payment account (hereinafter, the fifth payment account is referred to as ‘first intermediary account’) from the fourth payment account (as shown by arrow 426). As described in FIG. 3, the first intermediary (i.e., the fourth customer) has added the first intermediary account to the service application 122 as the default payment mode. The second issuer server 118 debits the payment amount from the fourth payment account and transfers the payment amount to the first intermediary account (as shown by arrow 428). The second issuer server 118 transmits a second funds transfer response to the payment network server 114, indicating that the payment amount has been transferred from the fourth payment account to the first intermediary account (as shown by arrow 430).

Based on the second funds transfer response, the payment network server 114 generates and transmits a second payment request to the first intermediary device 302 by way of the service application 122 being executed on the first intermediary device 302 (as shown by arrow 432). In one embodiment, the second payment request may be presented as a push notification by way of the service application 122 on the first intermediary device 302. The payment network server 114 requests, by way of the second payment request, the first intermediary to initiate a transfer of the payment amount to the second customer 106. The second payment request may also include information that indicates that the payment amount is already credited to the first intermediary account. The second payment request may further include the second social ID of the second social account to aid the first intermediary in identifying the second customer 106. The second payment request may also indicate a time frame (say, five hours) for completing the transfer of the payment amount to the second customer 106. In another embodiment, the payment network server 114 may block an amount equivalent to the payment amount from the first intermediary account and release the blocked amount after the first intermediary transfers the payment amount to the second customer 106.

Since the second customer 106 and the first intermediary are directly connected on the first social platform, the first intermediary may get in touch with the second customer 106 to obtain payment credentials (i.e., the details of the second payment account or the second digital wallet) of the second customer 106. In a non-limiting example, it is assumed that the first intermediary obtains the payment credentials of the second payment account of the second customer 106. Consequently, the first intermediary device 302 is used by the first intermediary to access the service application 122 for initiating a transfer of the payment amount to the second payment account of the second customer 106. By way of the service application 122, the first intermediary is allowed to use any payment mode to transfer the payment amount to the second payment account of the second customer 106. For example, the first intermediary may opt for a digital wallet that belongs to the first intermediary for transferring the payment amount to the second payment account of the second customer 106. In another example, the first intermediary may opt for a corresponding transaction card for transferring the payment amount to the second payment account of the second customer 106. In yet another example, the first intermediary may opt for the fifth payment account for transferring the payment amount to the second payment account of the second customer 106.

In a non-limiting example, it is assumed that the first intermediary selects the digital wallet. Based on the selection of a payment mode by the first intermediary, the service application 122 generates a third funds transfer request. The third funds transfer request is for transferring the payment amount from the digital wallet of the first intermediary to the second payment account of the second customer 106. The third funds transfer request may include the details of the second payment account of the second customer 106 and the information pertaining to the payment mode selected by the first intermediary. The first intermediary device 302 communicates the third funds transfer request to the payment network server 114 (as shown by arrow 434a). The payment network server 114 communicates the third funds transfer request to the first issuer server 116 maintaining the digital wallet of the first intermediary (as shown by arrow 434b). The first issuer server 116 transfers the payment amount from the digital wallet of the first intermediary to the second payment account maintained at the first issuer server 116 (as shown by arrow 436).

It will be apparent to a person of ordinary skill in the art that the scope of the invention is not limited to a single issuer maintaining payment accounts and digitals wallets of the first customer 102, the first intermediary, and the second customer 106. In another embodiment, issuers maintaining payment accounts and digitals wallets of the first customer 102, the first intermediary, and the second customer 106 may be different without deviating from the scope of the invention. In such a scenario, the transfer of funds among payment accounts and digitals wallets maintained at different issuers is performed by one or more techniques known to those of ordinary skill in the art. In another embodiment, the fourth payment account of the payment network may be maintained at the first issuer instead of the second issuer. In such a scenario, the functions performed by the second issuer server 118 are performed by the first issuer server 116, without deviating from the scope of the invention.

The first issuer server 116 transmits a third funds transfer response to the first intermediary device 302 and the payment network server 114, indicating that the payment amount is successfully transferred to the second payment account (as shown by arrows 438a and 438b, respectively). The third funds transfer response may also include details of the transfer such as a payment ID. Based on the third funds transfer response, the payment network server 114 transmits a third notification to the first customer device 104 by way of the service application 122, indicating that the payment amount is successfully transferred to the second customer 106 (as shown by arrow 440).

In one embodiment, the payment network server 114 may reward intermediaries with monetary benefits for facilitating P2P payments, thereby incentivizing and promoting registration of customers as intermediaries. For example, the payment network server 114 generates and communicates a fourth funds transfer request to the second issuer server 118 for initiating a credit and transfer of a nominal amount to the digital wallet of the first intermediary from the fourth payment account of the payment network (as shown by arrow 442). The nominal amount is a reward to the first intermediary for facilitating the P2P payment and may be included as a part of the service fee charged to the first customer 102. For example, the nominal amount may be equal to ‘$1’. Therefore, the second issuer server 118 transfers ‘$1’ from the fourth payment account to the digital wallet of the first intermediary (as shown by arrow 444). Consequently, the second issuer server 118 transmits a fourth funds transfer response to the payment network server 114, indicating that the nominal amount is successfully transferred to the digital wallet of the first intermediary (as shown by arrow 446).

FIG. 4D represents a process flow diagram 400B that illustrates an exemplary scenario for facilitating a P2P payment, in accordance with another embodiment of the present invention. The process flow diagram 400B involves the first customer device 104, the first social platform server 110, the payment network server 114, the first issuer server 116, the second issuer server 118, the service application 122, and the first intermediary device 302.

As described in the foregoing description of FIG. 4B, the payment network server 114 transmits the second payment request to the first intermediary device 302 by way of the service application 122 (as shown by arrow 432). By way of the second payment request, the first intermediary is instructed to initiate the transfer of the payment amount to the second customer 106 within the stipulated time frame. However, in a scenario where the payment amount is not transferred to the second payment account of the second customer 106 by the first intermediary within the time frame, the payment network server 114 initiates a reversal of the P2P payment.

With reference to FIG. 4D, it is assumed that the payment amount is not transferred to the second payment account within the time frame. Therefore, the payment network server 114 communicates a fifth funds transfer request to the first issuer server 116 for transferring the payment amount from the digital wallet of the first intermediary to the fourth payment account (as shown by arrow 448). The first issuer server 116 transfers the payment amount from the digital wallet of the first intermediary to the fourth payment account (as shown by arrow 450). The first issuer server 116 transmits a fifth funds transfer response to the payment network server 114, indicating that the payment amount is successfully transferred to the fourth payment account (as shown by arrow 452).

The payment network server 114, then, communicates a sixth funds transfer request to the second issuer server 118 for transferring the payment amount and the service fee from the fourth payment account to the first payment account (as shown by arrow 454). The second issuer server 118 transfers the payment amount and the service fee from the fifth payment account to the first payment account (as shown by arrow 456). The second issuer server 118 transmits a sixth funds transfer response to the payment network server 114, indicating that the payment amount and the service fee are successfully transferred to the first payment account (as shown by arrow 458). Based on the sixth funds transfer response, the payment network server 114 transmits a fourth notification to the first customer device 104 by way of the service application 122, indicating that the P2P payment has failed and that the payment amount and the service fee are transferred back to the first payment account (as shown by arrow 460).

FIGS. 5A and 5B represent a block diagram that illustrates an exemplary scenario 500 for selecting an optimal link for facilitating a P2P payment, in accordance with an embodiment of the present invention. The exemplary scenario 500 is explained in conjunction with FIGS. 4A-4C. The exemplary scenario 500 includes the first set of links (designated as ‘first set of links 502’) and the first subset of links (designated as ‘first subset of links 504’).

The payment network server 114 receives the first set of links 502 from the first social platform server 110, as described in the foregoing in FIG. 4A. In a non-limiting example, it is assumed that the first set of links 502 includes a first link 506, a second link 508, and a third link 510. Each link in first set of links 502 is indicative of a manner in which the first and second customers 102 and 106 are connected to each other on the first social platform (i.e., the manner in which the first and second social accounts are connected). In a non-limiting example, it is assumed that the first and second social accounts are not directly connected on the first social platform, which means that the second customer 106 is not included in the contacts of the first customer 102 in the first social account.

The first link 506 indicates that the first customer 102 is directly connected to the first intermediary on the first social platform and the first intermediary is directly connected to the second customer 106 on the first social platform. In other words, the first link 506 indicates that the first social account is directly connected to the fourth social account and the fourth social account is directly connected to the second social account, on the first social platform. Similarly, the second link 508 indicates that the first customer 102 is directly connected to the first intermediary, the first intermediary is directly connected to a fifth customer (not shown), and the fifth customer is directly connected to the second customer 106, on the first social platform. The fifth customer may have a fifth social account on the first social platform. In other words, the second link 508 indicates that the first social account is directly connected to the fourth social account, the fourth social account is directly connected to the fifth social account, and the fifth social account is directly connected to the second social account, on the first social platform. Similarly, the third link 510 indicates that the first customer 102 is directly connected to a sixth customer (not shown), that the sixth customer is directly connected to a seventh customer (not shown), and that the seventh customer is directly connected to the second customer 106, on the first social platform. In other words, the third link 510 indicates that the first social account is directly connected to a social account of the sixth customer, the social account of the sixth customer is directly connected to a social account of the seventh customer, and the social account of the seventh customer is directly connected to the second social account, on the first social platform.

The payment network server 114 stores, in the memory of the payment network server 114, a list of customers who have registered as intermediaries for the P2P payment service. In a non-limiting example, it is assumed that the fifth customer is registered as an intermediary, and the sixth and seventh customers are not registered as intermediaries. Consequently, the payment network server 114 discards, from the first set of links, those links that include customers who are not registered as intermediaries for the P2P payment service. Thus, the payment network server 114 discards the third link 510 as the third link 510 includes the sixth and seventh customers. After discarding the third link 510, the remaining links in the first set of links 502, i.e., the first and second links 506 and 508, from the first subset of links 504.

After the identification of the first subset of links 504, the payment network server 114 selects an optimal link (e.g., the first optimal link of FIG. 4A) from the first subset of links 504. In one exemplary scenario, the payment network server 114 may select the first link 506 as the optimal link as the first link 506 has the least count of intermediaries. It will be apparent those of skill in the art the selection of the optimal link may be based on other criteria, without deviating from the scope of the invention. For example, in another embodiment, the payment network server 114 may assign a rank to each link in the first subset of links 504 and select the link having the highest rank as the optimal link. The rank may be assigned based on various parameters such as count of intermediaries in each link, a number of successful funds transfers performed by each intermediary in each link, a credit score of each intermediary, or the like.

FIGS. 6A-6C, collectively represent a process flow diagram 600 that illustrates another exemplary scenario for facilitating a P2P payment, in accordance with another embodiment of the present invention. The process flow diagram 600 involves the first customer device 104, the first social platform server 110, the second social platform server 112, the payment network server 114, the first issuer server 116, the second issuer server 118, the service application 122, and a third customer device 602 of the fifth customer. In a non-limiting example, it is assumed that the first customer 102 has already enrolled for availing the P2P payment service and wants to make a P2P payment to the third customer 108 who may not be enrolled for the P2P payment service.

For making the P2P payment to the third customer 108, the first customer 102 accesses the service application 122 on the first customer device 104 and logs into the service application 122. The first customer device 104 presents a UI of the service application 122 thereon to allow the first customer 102 to initiate the P2P payment. By way of the UI, the first customer 102 is prompted to enter a social ID of a social account that belongs to the first customer 102 and another social ID of a social account that belongs to the third customer 108. The first customer 102 enters the first and third social IDs (e.g., the first and third social links) associated with the first and third social accounts, respectively, in the UI for initiating the P2P payment (as shown by arrow 604). The third social account belongs to the third customer 108, as described in FIG. 1.

The service application 122 generates a third payment request for the P2P payment. The third payment request includes the first and third social IDs. The first customer device 104 communicates the third payment request to the payment network server 114 (as shown by arrow 606). Based on the first and third social IDs included in the third payment request, the payment network server 114 determines that the first and third social accounts are maintained at different social platforms, i.e., the first social account is maintained at the first social platform and the third social account is maintained at the second social platform. The payment network server 114 communicates the first social ID to the first social platform server 110 for requesting the first social platform server 110 to communicate a first social graph of the first social account to the payment network server 114 (as shown by arrow 608). The payment network server 114 further communicates the third social ID to the second social platform server 112 for requesting the second social platform server 112 to communicate the second social graph of the third social account to the payment network server 114 (as shown by arrow 610).

The first social platform server 110 generates the first social graph for the first social account (as shown by arrow 612). Similarly, the second social platform server 112 generates the second social graph for the third social account (as shown by arrow 614). The first and second social graphs include various nodes. The nodes in the first social graph are indicative of a second set of social accounts corresponding to a second set of customers that are directly or indirectly connected to the first customer 102 on the first social platform. For example, the first social graph may include first through third nodes. The first and second nodes may include social account details of two customers who are directly connected to the first customer 102 on the first social platform. The third node may be connected to the second node and may include social account details of another customer who is directly connected to the customer associated with the second node. Thus, the customer associated with the third node is indirectly connected to the first customer 102 on the first social platform. Similarly, the nodes in the second social graph are indicative of a third set of social accounts corresponding to a third set of customers that are directly or indirectly connected to the third customer 108 on the second social platform. For example, the second social graph may include fourth and fifth nodes. The fourth and fifth nodes may be indicative of social account details of two customers who are directly connected to the third customer 108 on the second social platform. It will be apparent to a person of ordinary skill in the art that the first and second social graphs may include any number of nodes without departing from the spirit of the invention. The first and second social platforms servers 110 and 112 communicate the first and second social graphs to the payment network server 114, respectively (as shown by arrows 616 and 618, respectively).

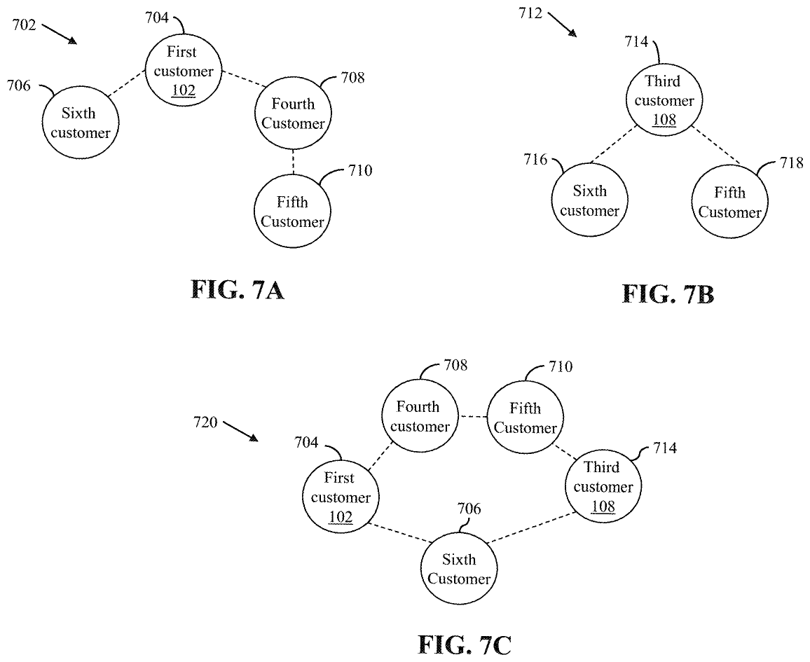

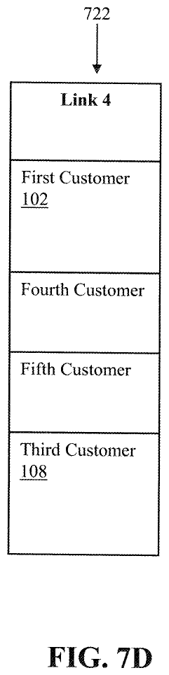

Based on the first and second social graphs, the payment network server 114 determines a second optimal link that connects the first and third customers 102 and 108 (as shown by arrow 620). In one embodiment, for determining the second optimal link, the payment network server 114 may identify nodes that are common in the first and second social graphs. In other words, the payment network server 114 may identify those customers whose social account details are included in both the first and second social graphs. For example, when the customer associated with the third node in the first social graph is same as the customer associated with the fifth node in the second social graph, the third and fifth nodes may be considered common nodes. After the identification of all common nodes in the first and second social graphs, the payment network server 114 may merge the first and second social graphs to obtain a merged social graph. The merged social graph may include a single instance of the common nodes. For example, the merged social graph may include one of the third and fifth nodes. After obtaining the merged social graph, the payment network server 114 may determine the second optimal link from the merged social graph. The second optimal link may be indicative of a set of social accounts corresponding to customers who are registered with the payment network server 114 as intermediaries for the P2P payment service and connect the first and third customers 102 and 108. The determination of the second optimal link is explained in detail in conjunction with FIGS. 7A-7D. In a non-limiting example, it is assumed that the second optimal link determined by the payment network server 114 is indicative of social accounts of two intermediaries, i.e., the first intermediary and the fifth customer (hereinafter, the fifth customer is referred to as ‘second intermediary’).

After the second optimal link is determined, the payment network server 114 requests the first customer 102 to provide a payment amount for which the P2P payment is to be made (as shown by arrow 622). The first customer 102 enters the payment amount (say, ‘$100’) in the service application 122 (as shown by arrow 624) and provides consent to pay the service fee (e.g., ‘$5’). The service application 122 may also prompt the first customer 102 to select a payment mode for making the P2P payment. In a non-limiting example, it is assumed that the first customer 102 selects the first transaction card as the payment mode. The first customer device 104 communicates information pertaining to the payment amount and the selected payment mode to the payment network server 114 (as shown by arrow 626).

The payment network server 114 communicates a seventh funds transfer request to the first issuer server 116 (as shown by arrow 628). The seventh funds transfer request includes the card details of the first transaction card, the information pertaining to the payment amount and the service fee, and the details of the fourth payment account of the payment network. The first issuer server 116 transfers the payment amount and the service fee (i.e., a total of ‘$105’) from the first payment account to the fourth payment account based on the seventh funds transfer request (as shown by arrow 630). The first issuer server 116 transmits a seventh funds transfer response to the payment network server 114, indicating that the payment amount and the service fee have been successfully transferred to the fourth payment account (as shown by arrow 632).

Based on the seventh funds transfer response, the payment network server 114 communicates an eighth funds transfer request to the second issuer server 118, requesting the second issuer server 118 to transfer the payment amount (e.g., ‘$100’) from the fourth payment account to the first intermediary account (as shown by arrow 634). The first intermediary account may have been listed as the default payment mode by the first intermediary during the intermediary registration process (as explained in FIG. 3). The second issuer server 118 transfers the payment amount from the fourth payment account to the first intermediary account (as shown by arrow 636). The second issuer server 118 transmits an eighth funds transfer response to the payment network server 114, indicating that the payment amount has been transferred from the fourth payment account to the first intermediary account (as shown by arrow 638).

Based on the eighth funds transfer response, the payment network server 114 generates and transmits a fourth payment request to the first intermediary device 302 (as shown by arrow 640). By way of the fourth payment request, the payment network server 114 requests the first intermediary to initiate a transfer of the payment amount to the second intermediary. The fourth payment request may include information that indicates that the payment amount is already credited to the first intermediary account and the time frame within which the first intermediary is required to transfer the payment amount to the second intermediary. In one embodiment, the fourth payment request may further include payment credentials of the second intermediary and social account details of the second intermediary. For example, the fourth payment request may include details of a sixth payment account which is listed as a default payment mode for the P2P payment service by the second intermediary. Hereinafter, the sixth payment account is referred to as ‘second intermediary account’. In another embodiment, the fourth payment request may not include the payment credentials of the second intermediary. The payment network server 114 may further block an amount equivalent to the payment amount from the first intermediary account and release the blocked amount after the payment amount is transferred to the third customer 108.

The first intermediary device 302 receives the fourth payment request from the payment network server 114 and presents the fourth payment request to the first intermediary by way of the service application 122 that runs on the first intermediary device 302. In one embodiment, when the fourth payment request does not include the payment credentials of the second intermediary, the first intermediary may obtain the payment credentials of the second intermediary by contacting the second intermediary. Based on the fourth payment account request, the first intermediary generates a ninth funds transfer request by using the service application 122 that runs on the first intermediary device 302. The ninth funds transfer request is for transferring the payment amount from the digital wallet of the first intermediary to the second intermediary account. It will be apparent to a person of ordinary skill in the art that the first intermediary may select any other payment mode for transferring the payment amount to the second intermediary account of the second intermediary. The ninth funds transfer request may include details of the second intermediary account and the information pertaining to the payment mode selected by the first intermediary. The first intermediary device 302 communicates the ninth funds transfer request to the payment network server 114 (as shown by arrow 642a). The payment network server 114 communicates the ninth funds transfer request to the first issuer server 116 maintaining the digital wallet of the first intermediary and the second intermediary account (as shown by arrow 642b). Based on the ninth funds transfer request, the first issuer server 116 transfers the payment amount from the digital wallet of the first intermediary to the second intermediary account (as shown by arrow 644). The first issuer server 116 transmits a ninth funds transfer response to the first intermediary device 302 and the payment network server 114, indicating that the payment amount is successfully transferred from the digital wallet of the first intermediary to the second intermediary account (as shown by arrows 646a and 646b). It is assumed that the payment amount is transferred to the second intermediary account within the time frame.

Based on the ninth funds transfer response, the payment network server 114 generates a fifth payment request. The payment network server 114 then transmits the fifth payment request to the third customer device 602 of the second intermediary (as shown by arrow 648). Hereinafter, the third customer device 602 is referred to as ‘second intermediary device 602’). By way of the fifth payment request, the payment network server 114 requests the second intermediary to transfer the payment amount to the third customer 108. The fifth payment request may include the third social ID of the third social account to aid the second intermediary in identifying the third customer 108. The fifth payment request may further include information that indicates that the payment amount is already credited to the second intermediary account. Further, the fifth payment request may include the time frame within which the second intermediary is required to transfer the payment amount to the third customer 108. In one embodiment, the payment network server 114 may block an amount equivalent to the payment amount from the second intermediary account when the second intermediary receives the payment amount from the first intermediary and release the blocked amount after the second intermediary transfers the payment amount to the third customer 108.

Since the third customer 108 and the second intermediary are directly connected on the first social platform, the second intermediary may get in touch with the third customer 108 to obtain payment credentials of the third customer 108 (i.e., the details of the third payment account or the third digital wallet). In a non-limiting example, it is assumed that the second intermediary acquires the details of the third payment account of the third customer 108. Consequently, the second intermediary device 602 is used by the second intermediary to access the service application 122 for initiating a transfer of the payment amount to the third payment account of the third customer 108. For example, the second intermediary may opt for a digital wallet that belongs to the second intermediary for transferring the payment amount to the third payment account of the third customer 108. In another example, the second intermediary may opt for a corresponding transaction card for transferring the payment amount to the third payment account of the third customer 108. In another example, the second intermediary may opt for a corresponding payment account for transferring the payment amount to the third payment account of the third customer 108.

In a non-limiting example, it is assumed that the second intermediary selects the second intermediary account. Based on the selection of a payment mode by the second intermediary, the service application 122 generates a tenth funds transfer request. The tenth funds transfer request is for transferring the payment amount from the second intermediary account to the third payment account of the third customer 108. The tenth funds transfer request may include the details of the third payment account of the third customer 108 and the information pertaining to the payment mode selected by the second intermediary. The second intermediary device 602 communicates the tenth funds transfer request to the payment network server 114 (as shown by arrow 650a). The payment network server 114 communicates the tenth funds transfer request to the first issuer server 116 maintaining the second intermediary account and the third payment account (as shown by arrow 650b). The first issuer server 116 transfers the payment amount from the second intermediary account to the third payment account (as shown by arrow 652) based on the tenth funds transfer request. The first issuer server 116 transmits a tenth funds transfer response to the second intermediary device 602 and the payment network server 114, indicating that the payment amount is successfully transferred to the third payment account (as shown by arrow 654a and 654b). The tenth funds transfer response may also include details of the transfer such as a payment ID of the transfer. In a non-limiting example, it is assumed that the payment amount is transferred to the third payment account within the time frame. Based on the tenth funds transfer response, the payment network server 114 transmits a fifth notification to the first customer device 104 by way of the service application 122, indicating that the payment amount is successfully transferred to the third customer 108 (as shown by arrow 656).

The payment network server 114 generates and communicates an eleventh funds transfer request to the second issuer server 118 for initiating a credit and transfer of a nominal amount to the first and second intermediary accounts from the fourth payment account (as shown by arrow 658). For example, the second issuer server 118 may transfer ‘$1’ to the first and second intermediary accounts (as shown by arrow 660). Consequently, the second issuer server 118 transmits an eleventh funds transfer response to the payment network server 114, indicating that the nominal amount is transferred to the first and second intermediary accounts (as shown by arrow 662).

It will be apparent to those of the skill in the art that the P2P payment may be reversed by the payment network server 114 if the payment amount is not transferred within the time frame by the first and second intermediaries, as described in the foregoing description of FIG. 4D. In one embodiment, when the first optimal link (as described in FIGS. 4A-4C) selected by the payment network server 114 is associated with multiple intermediaries, the payment network server 114 may facilitate the transfer of payment amount among the multiple intermediaries in a manner similar to the second optimal link.

FIG. 7A is a block diagram that illustrates the first social graph (designated as ‘first social graph 702’) generated by the first social platform server 110, in accordance with an embodiment of the present invention.

The first social platform server 110 generates the first social graph 702 based on the request from the payment network server 114, as described in the foregoing description of FIG. 6A. The first social graph 702 is indicative of customers (i.e., social accounts of customers) who are directly or indirectly connected to the first customer 102 (i.e., the first social account) on the first social platform. It will be apparent to those of skill in the art that the first social graph 702 of FIG. 7A is highly simplistic and an exemplary representation of social graphs that may be generated by the first social platform server 110.

The first social graph 702 indicates that the first customer 102 (represented as a first root node 704) is directly connected to the sixth customer (represented as a first node 706) and the fourth customer, i.e., the first intermediary, (represented by the second node 708), on the first social platform. In other words, the first social graph 702 indicates that the first social account is directly connected to the fourth social account and a social account of the sixth customer, on the first social platform. The first social graph 702 further indicates that the first intermediary is directly connected to the fifth customer, i.e., the second intermediary, (represented as a third node 710) on the first social platform. In other words, the fifth social account of the second intermediary is directly connected to the fourth social account and indirectly connected to the first social account, on the first social platform.

FIG. 7B is a block diagram that illustrates the second social graph (designated as ‘second social graph 712’) generated by the second social platform server 112, in accordance with an embodiment of the present invention.

The second social platform server 112 generates the second social graph 712 based on the request from the payment network server 114, as described in the foregoing description of FIG. 6A. The second social graph 712 is indicative of customers (i.e., social accounts of customers) who are directly or indirectly connected to the third customer 108 (i.e., the third social account) on the second social platform. It will be apparent to those of skill in the art that the second social graph 712 of FIG. 7B is highly simplistic and an exemplary representation of social graphs that may be generated by the second social platform server 112.

The second social graph 712 indicates that the third customer 108 (represented as a second root node 714) is directly connected to the sixth customer (represented by a fourth node 716) and the second intermediary (represented as a fifth node 718), on the second social platform. In other words, the second social graph 712 indicates that the third social account is directly connected to a sixth social account of the second intermediary and another social account of the sixth customer, on the second social platform.

FIG. 7C is a block diagram that illustrates the merged social graph (designated as ‘merged social graph 720’) generated by the payment network server 114, in accordance with an embodiment of the present invention.

When the payment network server 114 receives the first and second social graphs 702 and 712 from the first and second social platforms servers 110 and 112, respectively, the payment network server 114 identifies those customers whose social account details are included in both the first and second social graphs 702 and 712 for identifying common nodes. For example, the first and second social graphs 702 and 712 both include the social account details of the second intermediary (i.e., the fifth customer) and the sixth customer. Thus, the first node 706 and the fourth node 716 in the first and second social graphs 702 and 712, respectively, are the common nodes. Likewise, the third node 710 and the fifth node 718 in the first and second social graphs 702 and 712, respectively, are the common nodes. The payment network server 114 then merges the first and second social graphs 702 and 712 to generate the merged social graph 720. The merged social graph 720 includes one instance of each common node.

FIG. 7D is a block diagram that illustrates the second optimal link (designated as ‘second optimal link 722’) determined by the payment network server 114 for facilitating a P2P payment, in accordance with another embodiment of the present invention.

Based on the merged social graph 720, the payment network server 114 determines that the second and third nodes 708 and 710 connect the first and third customers 102 and 108. Likewise, the first node 706 also connects the first and third customers 102 and 108. Based on the information stored in the memory of the payment network server 114, the payment network server 114 determines that the first and second intermediaries associated with the second and third nodes 708 and 710, respectively, are registered as intermediaries for the P2P payment service and the sixth customer associated with the first node 706 is not registered as an intermediary. Consequently, the payment network server 114 determines that the link indicative of the first and second intermediaries is the second optimal link 722.

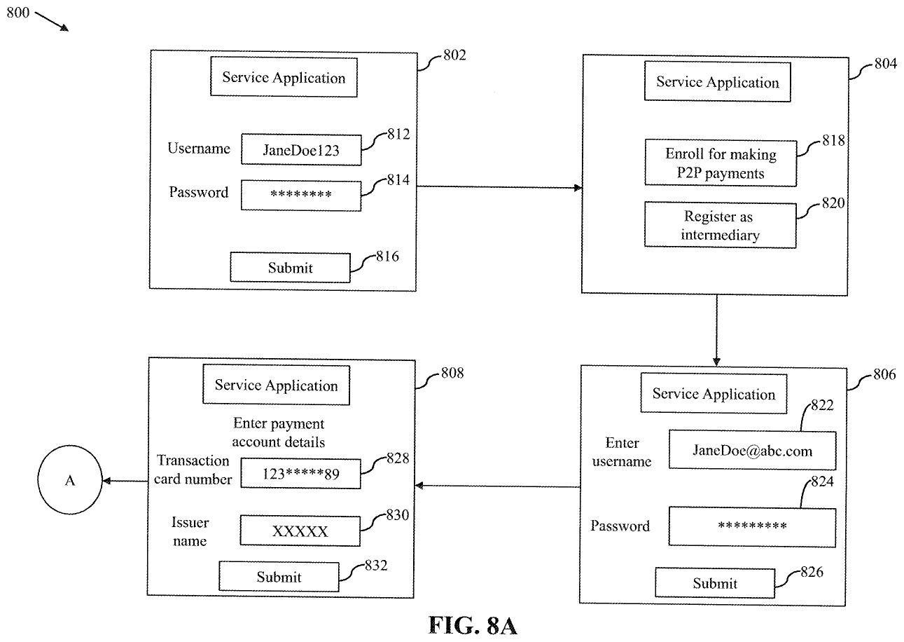

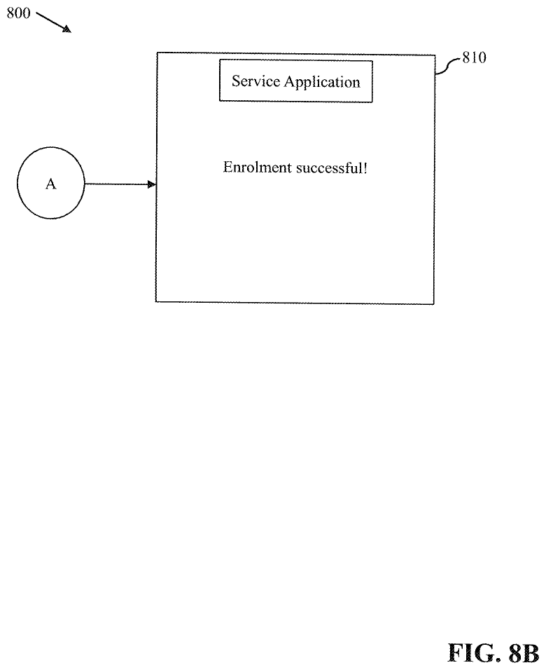

FIGS. 8A and 8B represent an exemplary scenario 800 that illustrates first through fifth exemplary UI screens 802, 804, 806, 808, and 810 that are rendered on a display of the first customer device 104, in accordance with an embodiment of the present invention. The UI screens 802-810 represent an interactive interface of the service application 122. The first customer 102 may have already signed up for the service application 122 by providing a username and a password, as known to those skilled in the art.

When the first customer 102 accesses the service application 122, the UI screen 802 is rendered on the display of the first customer device 104. The UI screen 802 presents first and second text boxes 812 and 814, which allow the first customer 102 to enter username (here, ‘JaneDoe123’) and password of the first customer 102, respectively, for logging into the service application 122. The UI screen 802 further presents a first submit button 816, which is selectable by the first customer 102. The first customer 102 enters the username and password of the first customer 102 in the first and second text boxes 812 and 814, respectively, and selects the first submit button 816. The service application 122 serves as a gateway to the payment network server 114, and therefore the username and password entered by the first customer 102 are communicated to the payment network server 114.

When the first customer 102 is successfully authenticated by the payment network server 114, the UI screen 804 is rendered on the display of the first customer device 104. The UI screen 804 presents first and second customer-selectable options 818 and 820. The first and second customer-selectable options 818 and 820 allow the first customer 102 to enroll for availing the P2P payment service and register as an intermediary for the P2P payment service, respectively. In the current embodiment, it is assumed that the first customer 102 selects the first customer-selectable option 818. When the first customer 102 selects the first customer-selectable option 818, the UI screen 806 is rendered on the display of the first customer device 104.

The UI screen 806 includes a second message requesting the first customer 102 to enter login credentials (here, username and password of corresponding social account) of a social account of the first customer 102. The UI screen 806 presents third and fourth text boxes 822 and 824, respectively, which allow the first customer 102 to enter the username (i.e., JaneDoe@abc.com) and password associated with the first social account, respectively. The UI screen 806 further presents a second submit button 826, which is selectable by the first customer 102. When the first customer 102 selects the second submit button 826, the username and the password entered by the first customer 102 are communicated to the payment network server 114. The payment network server 114 communicates with the first social platform server 110 to validate the first social account, as described in the foregoing description of FIG. 2. When the first social account is validated, the service application 122 renders the UI screen 808 on the display of the first customer device 104.

The UI screen 808 includes a third message requesting the first customer 102 to enter details of a payment mode (i.e., the first transaction card details) of the first customer 102. For example, the UI screen 808 may present a fifth text box 828, which allows the first customer 102 to enter the first transaction card number (i.e., 123*****89). The UI screen 808 may further present a sixth text box 830 that allows the first customer 102 to enter a name of the first issuer that issued the first transaction card. The UI screen 808 further presents a third submit button 832, which is selectable by the first customer 102. When the first customer 102 selects the third submit button 832, the first transaction card details are communicated to the payment network server 114. As described in the foregoing description of FIG. 2, the payment network server 114 communicates with the first issuer server 116 to validate the first transaction card and stores the first transaction card details in the memory of the payment network server 114, thereby enrolling the first customer 102 for the P2P payment service. Consequently, the service application 122 renders the UI screen 810 on the display of the first customer device 104. The UI screen 810 includes a fourth message that indicates successful enrollment of the first customer 102 for the P2P payment service.

It will be apparent to those of skill in the art that UI screens rendered by the service application 122 to facilitate registration of customers as intermediaries may be similar to the UI screens 802-810. In another embodiment, the UI screen 808 may allow the first customer 102 to add other payment modes (e.g., digital wallets, payment accounts, or the like) as well.

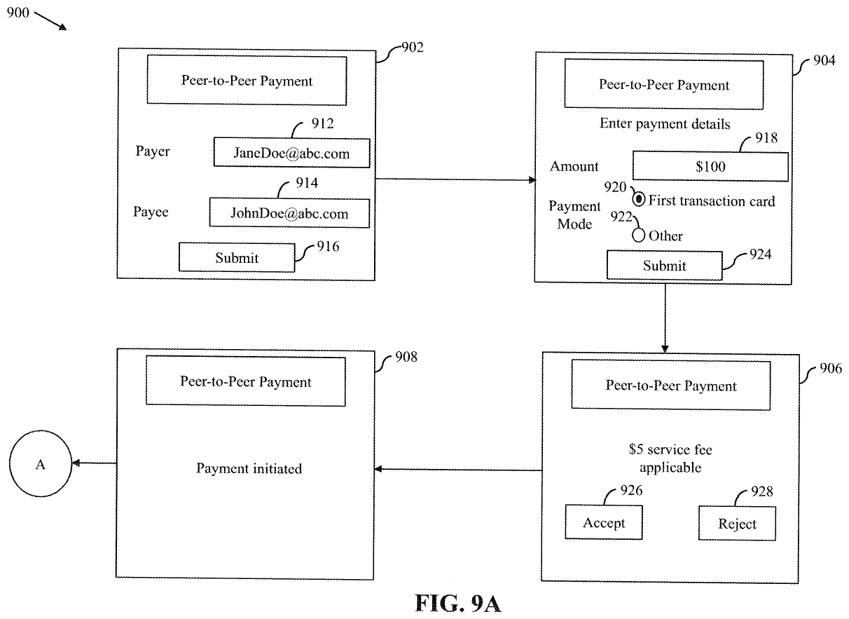

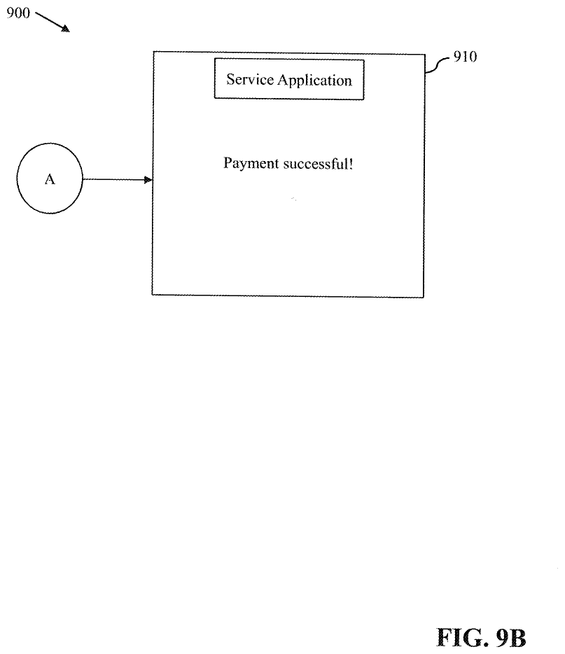

FIGS. 9A and 9B represent an exemplary scenario 900 that illustrates sixth through tenth UI screens 902, 904, 906, 908, and 910 that are rendered on the display of the first customer device 104, in accordance with another embodiment of the present invention. The UI screens 902-910 represent the interactive interface of the service application 122.

FIGS. 9A and 9B are explained in conjunction with FIGS. 4A-4C. When the first customer 102 logs into the service application 122 for making the P2P payment to the second customer 106, the UI screen 902 is rendered on the display of the first customer device 104. The UI screen 902 presents seventh and eighth text boxes 912 and 914, respectively, which allow the first customer 102 to enter the first social ID (here, the first social link ‘JaneDoe@abc.com’) that belongs to the first customer 102 and the second social ID (here, the second social link ‘JohnDoe@abc.com’) that belongs to the second customer 106, respectively. The UI screen 902 further presents a fourth submit button 916, which is selectable by the first customer 102. The first customer 102 enters the first and second social IDs in the seventh and eighth text boxes 912 and 914, respectively, and selects the fourth submit button 916. The service application 122 serves as a gateway to the payment network server 114, and therefore the first and second social IDs entered by the first customer 102 are communicated to the payment network server 114. The service application 122 renders the UI screen 904 when the first optimal link 506 is selected by the payment network server 114.

The UI screen 904 includes a fifth message requesting the first customer 102 to enter the payment amount and choose a payment mode. The UI screen 904, further, includes a ninth text box 918 for entering the payment amount and third and fourth customer-selectable options 920 and 922, respectively, for selecting the payment mode. The third customer-selectable option 920 allows the first customer 102 to select the first transaction card (i.e., the payment mode added by the first customer 102) and the fourth customer-selectable option 922 allows the first customer 102 to select or add a payment mode other than the first transaction card. As described in the foregoing, the first customer 102 enters ‘$100’ as the payment amount and selects the first payment mode. The UI screen 904 also includes a fifth submit button 924, which is selectable by the first customer 102. After entering the payment amount and selecting the first transaction card as the payment mode, the first customer 102 may select the fifth submit button 924. The service application 122, then, renders the UI screen 906 on the display of the first customer device 104.

The UI screen 906 includes a sixth message, requesting the consent of the first customer 102 for paying the service fee. The UI screen 906, further, includes fifth and sixth customer-selectable options 926 and 928 for accepting or rejecting the service fee, respectively. If the first customer 102 selects the sixth customer-selectable option 928 (i.e., if the first customer 102 rejects the service fee), the service application 122 communicates the rejection of the service fee, by the first customer 102, to the payment network server 114. Consequently, the payment network server 114 may abort the payment. For the sake of simplicity, it is assumed that the first customer 102 selects the fifth customer-selectable option 926 (i.e., the first customer 102 accepts the service fee). The service application 122, thus, communicates the acceptance of the service fee, by the first customer 102, to the payment network server 114 and renders the UI screen 908. When the payment amount is successfully transferred to the second customer 106, the UI screen 910 is rendered on the display of the first customer device 104 to present the fifth notification to the first customer 102.

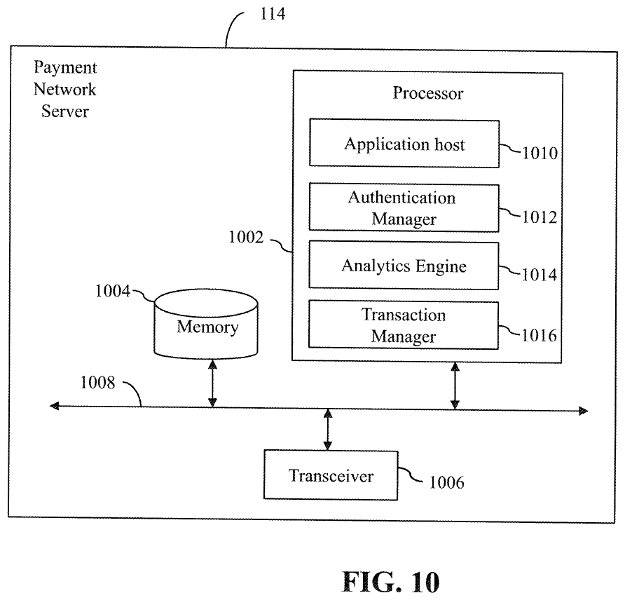

FIG. 10 is a block diagram that illustrates the payment network server 114, in accordance with an embodiment of the present invention. The payment network server 114 includes a processor 1002, a memory 1004, and a transceiver 1006. The processor 1002, the memory 1004, and the transceiver 1006 communicate with each other by way of a communication bus 1008. The processor 1002 includes an application host 1010, an authentication manager 1012, an analytics engine 1014, and a transaction manager 1016.

The processor 1002 includes suitable logic, circuitry, interfaces, and/or codes, executed by the circuitry, to facilitate P2P payments initiated by way of the service application 122. The processor 1002 stores, in the memory 1004, account profiles of the customers (e.g., the first customer 102 and the first and second intermediaries) who have enrolled or registered with the payment network server 114 for availing the P2P payment service offered by the service application 122. For example, an account profile of the first customer 102 may include social account details (such as social IDs of social accounts of the first customer 102), payment credentials (e.g., card details of the first transaction card, digital wallet details, or the like) of the first customer 102, authentication information of the first customer 102, and/or the like. The processor 1002 hosts the service application 122 that is executable on the first customer device 104 and the first and second intermediary devices 302 and 602. The processor 1002 authenticates the first customer 102 and the first and second intermediaries when the first customer 102 and the first and second intermediaries access the service application 122 and attempt to log into the service application 122.

In one embodiment, the processor 1002 selects an optimal link (e.g., the first optimal link 506) from a set of links (such as the first set of links 502) provided by a social platform server (such as the first or second social platform server 110 or 112). In another embodiment, the processor 1002 determines an optimal link (e.g., the second optimal link 506 and 722) based on social graphs (such as the first and second social graphs 702 and 712) provided by social platform servers (such as the first and second social platform servers 110 and 112). Examples of the processor 1002 may include, but are not limited to, an application-specific integrated circuit (ASIC) processor, a reduced instruction set computer (RISC) processor, a complex instruction set computer (CISC) processor, a field programmable gate array (FPGA), and the like. The processor 1002 executes operations for facilitating P2P payments by way of the application host 1010, the authentication manager 1012, the analytics engine 1014, and transaction manager 1016.

The application host 1010 executes operations for hosting the service application 122 that is executable on various devices, such as the first customer device 104 and the first and second intermediary devices 302 and 602. The application host 1010 may control the service application 122 and cause it to perform various operations (such as the rendering of the UI screens 802-810 and 902-910) as described in FIGS. 8A-8B, 9A-9B. By way of the UI screens 802-810, the application host 1010 allows customers (e.g., the first customer 102 and the first intermediary) to enroll for the P2P payment service and to register as intermediaries for the P2P payment service. By way of the UI screens 902-910, the application host 1010 allows customers (such as the first customer 102) to make P2P payments to other customers (as described in the foregoing descriptions of FIGS. 4A-4C and 6A-6C). The application host 1010 further stores the payment credentials provided by the enrolled and registered customers in the memory 1004. The application host 1010 further receives payment requests (such as the first and third payment requests) for P2P payments initiated by way of the service application 122.

The authentication manager 1012 authenticates customers (such as the first customer 102) who attempt to log into the service application 122. The authentication manager 1012 receives the authentication information from the service application 122. The authentication manager 1012 verifies whether the authentication information (such as the username and password) provided by the first customer 102 is valid. The authentication manager 1012 compares the username and password provided by the first customer 102 with the username and password stored in the account profile of the first customer 102. The first customer 102 is authenticated if the username and password provided by the first customer 102 match the username and password, respectively, stored in the account profile of the first customer 102. The authentication manager 1012 validates the authentication information by using various validation and verification techniques known in the art. Based on a result of the comparison, the authentication manager 1012 generates an authentication response that allows the first customer 102 to log into the service application 122.

The analytics engine 1014 selects or determine an optimal link (e.g., the first optimal link 506 or second optimal link 722) between a payer (e.g., the first customer 102) and a payee (e.g., the second or third customer 106 or 108) involved in the P2P payment initiated by the payee. The analytics engine 1014 selects or determines the optimal link based on a set of links or social graphs provided by social platform servers (e.g., the first social platform server 110 and/or the second social platform server 112). For example, the analytics engine 1014 analyses the first set of links 502 and selects the first optimal link 506 as described in the foregoing description of FIGS. 5A-5B. Likewise, the analytics engine 1014 analyzes the first and second social graphs 702 and 712 and determine the second optimal link 722 (as described in the foregoing description of FIGS. 7A-7D). Further, the analytics engine 1014 communicates with the first and second social platform servers 110 and 112 to validate social accounts (such as the first and fourth social accounts) of customers when the customers attempt to enroll for the P2P payment service and/or register as intermediaries for the P2P payment service.

The transaction manager 1016 facilitates P2P payments initiated by way of the service application 122. The transaction manager 1016 may generate funds transfer requests (such as the first, second, and third funds transfer requests) to issuers (such as the first and second issuer servers 116 and 118) for transferring funds between payment accounts and/or digital wallets. The transaction manager 1016 generates payment requests (such as the second, fourth, and fifth payment requests). Further, the transaction manager 1016 initiates reversal of a P2P payment when the P2P payment is not completed within the time frame (as described in foregoing description of FIG. 4D). Further, the transaction manager 1016 determines the nominal amount to be paid to the intermediaries (such as the first and second intermediaries) for facilitating the P2P payments and credit the nominal amount to payment accounts (such as the first and second intermediary accounts) of the intermediaries.

The memory 1004 includes suitable logic, circuitry, interfaces, and/or codes, executable by the circuitry, to store the account profiles of customers (such as the first customer 102 and the first and second intermediaries). The memory 1004 further stores the list of customers registered as intermediaries for the P2P payment service and a list of customers enrolled for the P2P payment service. Examples of the memory 1004 may include a random-access memory (RAM), a read-only memory (ROM), a removable storage drive, a hard disk drive (HDD), a flash memory, a solid-state memory, and the like. It will be apparent to a person skilled in the art that the scope of the invention is not limited to realizing the memory 1004 in the payment network server 114, as described herein. In another embodiment, the memory 1004 may be realized in form of a database server or a cloud storage working in conjunction with the payment network server 114, without departing from the scope of the invention.

The transceiver 1006 includes suitable logic, circuitry, interfaces, and/or codes, executable by the circuitry, to transmit and receive data over the communication network 120 using one or more communication network protocols. The transceiver 1006 transmits various requests and messages to the first, second, and third customer devices 104, 302, and 602, the first and second social platform servers 110 and 112, and the first and second issuer servers 116 and 118. The transceiver 1006 further receives various requests and messages from the first, second, and third customer devices 104, 302, and 602, the first and second social platform servers 110 and 112, and the first and second issuer servers 116 and 118. Examples of the transceiver 1006 may include, but are not limited to, an antenna, a radio frequency transceiver, a wireless transceiver, a Bluetooth transceiver, an ethernet port, a universal serial bus (USB) port, or any other device configured to transmit and receive data.

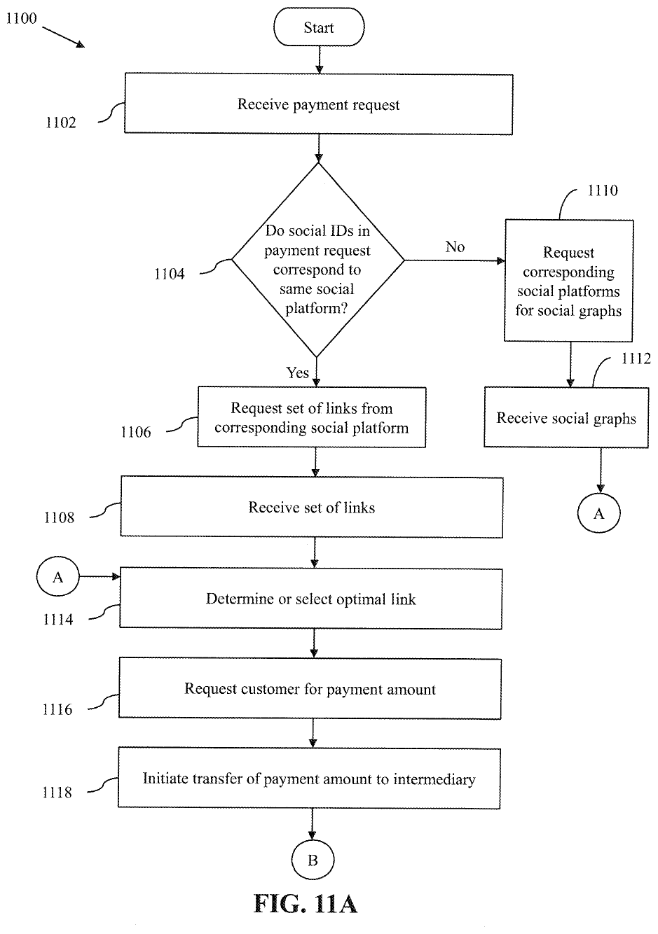

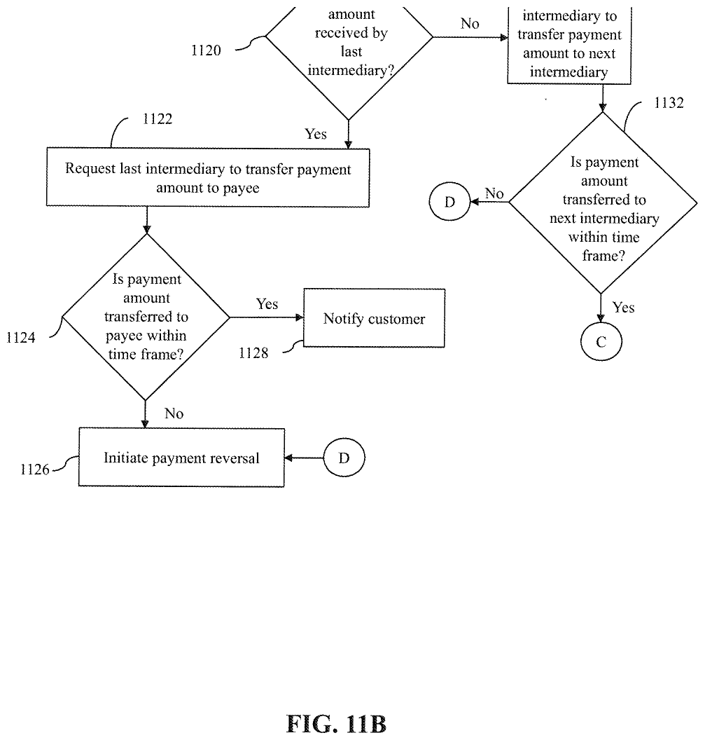

FIGS. 11A and 11B, collectively represent a flow chart 1100 that illustrates a method for facilitating a P2P payment, in accordance with an embodiment of the present invention. The first customer 102 (i.e., the payer) generates a payment request by way of the service application 122, running on the first customer device 104, for making a P2P payment to a payee. The payment request includes the first social ID of the first customer 102 and a payee's social ID of the payee. The service application 122 communicates the payment request to the payment network server 114.

At step 1102, the payment network server 114 receives the payment request. At step 1104, the payment network server 114 determines whether the first social ID and the payee's social ID correspond to the same social platform (i.e., the first social platform). If at step 1104, it is determined that the first social ID and the payee's social ID correspond to the first social platform, step 1106 is performed. At step 1106, the payment network server 114 requests the first social platform server 110 for a set of links that connect the first customer 102 and the payee on the first social platform. The first social platform server 110 determines the set of links and communicates the set of links to the payment network server 114 (as described in the foregoing descriptions of FIGS. 4A and 5A-5B). At step 1108, the payment network server 114 receives the set of links from the first social platform server 110. If at step 1104, it is determined that the first social ID and the payee's social ID correspond to different social platforms (i.e., the first and second social platforms, respectively), step 1110 is performed. At step 1110, the payment network server 114 requests the first and second social platform servers 110 and 112 for a first social graph of the first social account linked to the first social ID and a second social graph of payee's social account linked to the payee's social ID, respectively. As described in the foregoing, the first and second social platform servers 110 and 112 generate and communicate the first and second social graphs 702 and 712, respectively, to the payment network server 114. At step 1112, the payment network server 114 receives the first and second social graphs 702 and 712 from the first and second social platform servers 110 and 112, respectively. At step 1114, the payment network server 114 determines or selects an optimal link (e.g., the first and second optimal link described in FIGS. 4A-4D and 6A-6C, respectively) connecting the first customer 102 and the payee. In one embodiment, the payment network server 114 selects the optimal link from the set of links received from the first social platform server 110 (as described in the foregoing description of FIGS. 5A and 5B). In another embodiment, the payment network server 114 determines the optimal link based on the first and second social graphs 702 and 712 (as described in the foregoing description of FIGS. 7A-7D). The optimal link is indicative of a first set of customers registered as intermediaries (i.e., a first set of intermediaries) for the P2P payment service and connect the first customer 102 and the payee.

At step 1116, the payment network server 114 requests the first customer 102 for a payment amount of the P2P payment. The first customer 102 provides the first amount as the payment amount by way of the service application 122. Further, the first customer 102 may also select a payment mode (such as the first transaction card) for making the P2P payment for the first amount. The first customer device 104 communicates the payment amount (i.e., the first amount) and the payment mode to the payment network server 114. At step 1118, the payment network server 114 initiates (by way of funds transfer requests) a transfer of the first amount from the first payment account to a payment account of a first intermediary included in the first set of intermediaries (as described in the foregoing descriptions of FIGS. 4A-4C, 6A-6C). For the sake of simplicity, it is assumed that the payment account of the first intermediary is maintained at the first issuer. The first issuer server 116 transfers the first amount from the first payment account to the payment account of the first intermediary by way of the fourth payment account. At step 1120, the payment network server 114 determines whether the first amount is received by last intermediary included in the first set of intermediaries.

If at step 1120, it is determined that the first amount is received by the last intermediary, step 1122 is performed. At step 1122, the payment network server 114 requests the last intermediary to transfer the first amount to the payee within a time frame. At step 1124, the payment network server 114 determines if the first amount is transferred to the payee within the time frame. If at step 1124, it is determined that the first amount is not transferred to the payee within the given time frame, step 1126 is performed. At step 1126, the payment network server 114 initiates a payment reversal as described in the foregoing description of FIG. 4D. If at step 1124, it is determined that the first amount is transferred to the payee within the given time frame, step 1128 is performed. At step 1128, the payment network server 114 communicates a notification to the first customer 102, by way of the service application 122. The notification indicates that the first amount is successfully transferred to the payee. If at step 1120, it is determined that first amount is not received by the last intermediary, step 1130 is performed. At step 1130, the payment network server 114 requests the first intermediary to transfer, within the time frame, the first amount to a next intermediary included in the first set of intermediaries. At step 1132, the payment network server 114 determines if the first amount is transferred to the next intermediary within the time frame. If at step 1132, it is determined that the first amount is transferred to the next intermediary within the time frame, step 1120 is performed. If at step 1132, it is determined that the first amount is not transferred to the next intermediary within the time frame, step 1126 is performed.

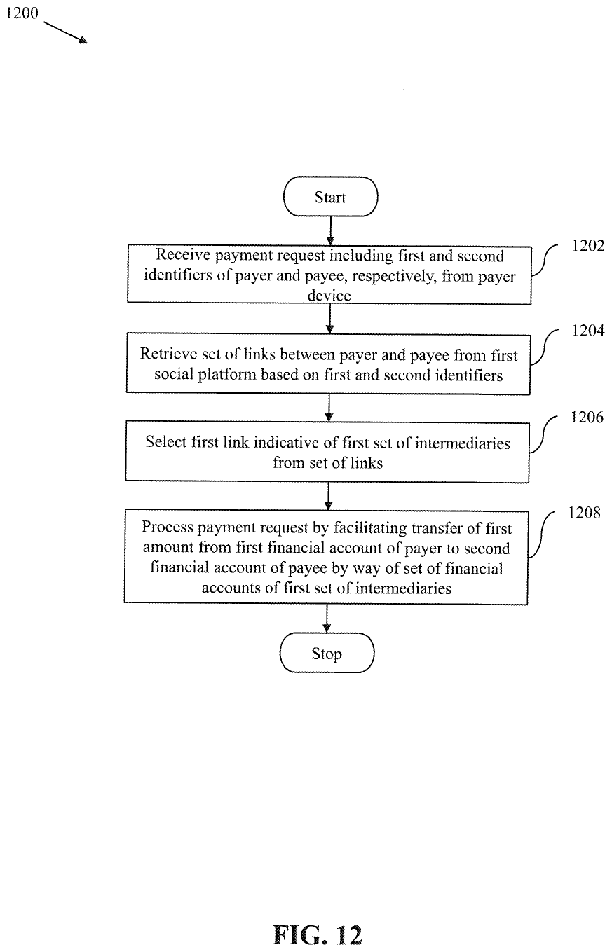

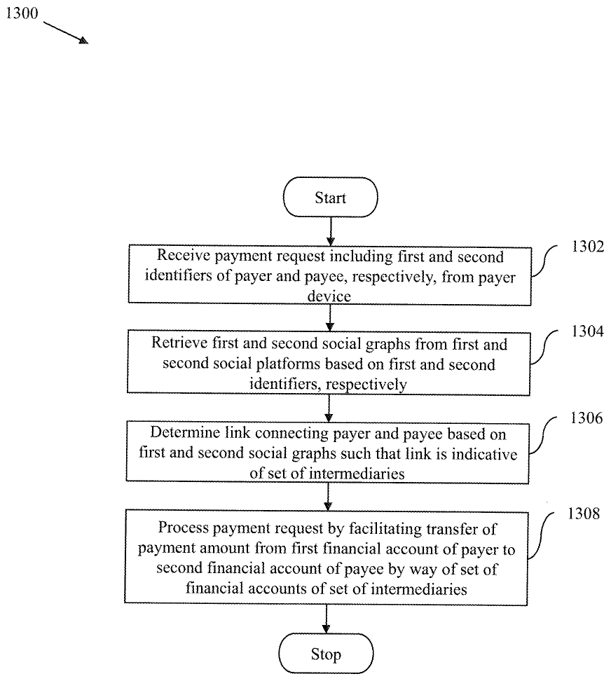

FIG. 12 represents a high-level flow chart 1200 that illustrates the method for facilitating P2P payments, in accordance with an embodiment of the present invention. At step 1202, the payment network server 114 receives the first payment request including the first and second social IDs of the payer (i.e., the first customer 102) and the payee (i.e., the second customer 106), respectively, from the payer device (i.e., the first customer device 104). The first payment request is initiated by the payer (i.e., the first customer 102) for making a payment of a first amount to the payee (i.e., the second customer 106). At step 1204, the payment network server 114 retrieves, from the first social platform server 110, the first set of links 502 based on the first and second social IDs. Each link in the first set of links 502 is indicative of a set of intermediaries that connects the payer (i.e., the first customer 102) and payee (i.e., the second customer 106) on the first social platform. At step 1206, the payment network server 114 selects the first optimal link 506, including the first set of intermediaries, from the first set of links 502. For example, the first optimal link 506 includes the first intermediary as described in FIG. 5B. At step 1208, the payment network server 114 processes the first payment request for facilitating the transfer of the first amount from a first financial account of the payer to a second financial account of the payee by way of a set of financial accounts of the first set of intermediaries.

FIG. 13 represents a high-level flow chart 1300 that illustrates the method for facilitating P2P payments, in accordance with another embodiment of the present invention. At step 1302, the payment network server 114 receives the third payment request including the first and third social IDs of the payer (i.e., the first customer 102) and the payee (i.e., the third customer 108), respectively, from the payer device (i.e., the first customer device 104). The third payment request is initiated by the payer (i.e., the first customer 102) for making a payment of a first amount to the payee (i.e., the third customer 108). At step 1304, the payment network server 114 retrieves, from the first social platform server 110, the first and second social graphs 702 and 712 based on the first and third social IDs, respectively. At step 1306, the payment network server 114 determines the second optimal link 722 connecting the payer (i.e., the first customer 102) and the payee (i.e., the third customer 108), based on the first and second social graphs 702 and 712. The second optimal link 722 is indicative of a set of intermediaries (for example, the first and second intermediaries as described in FIG. 7D). At step 1308, the payment network server 114 processes the third payment request for facilitating the transfer of the first amount from a first financial account of the payer (i.e., the first customer 102) to a second financial account of the payee (i.e., the third customer 108) by way of a first set of financial accounts of the set of intermediaries (as described in FIGS. 6A-6C).

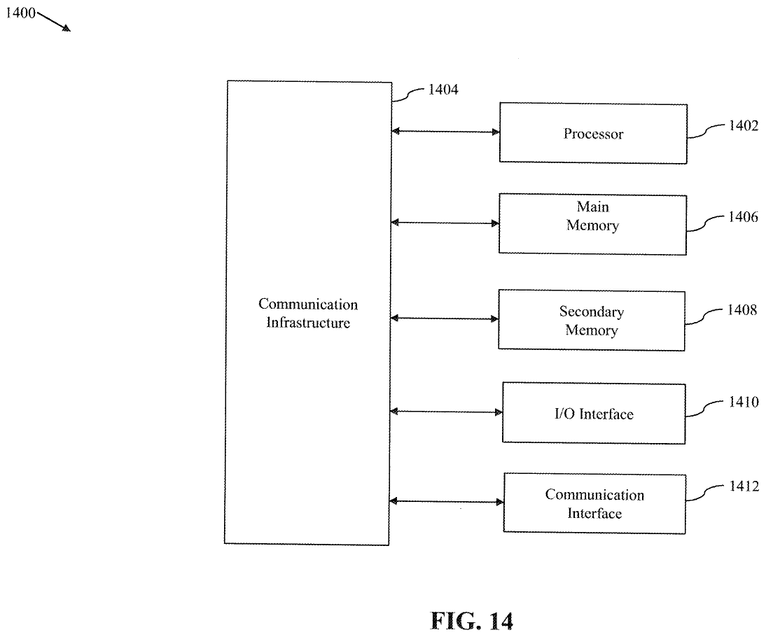

FIG. 14 is a block diagram that illustrates system architecture of a computer system 1400, in accordance with an embodiment of the present invention. An embodiment of present invention, or portions thereof, may be implemented as computer readable code on the computer system 1400. In one example, the first customer device 104, the first and second intermediary devices 302 and 602, the first and second social platform servers 110 and 112, the payment network server 114, and the first and second issuer servers 116 and 118 of FIG. 1 may be implemented in the computer system 1400 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 11A and 11B, 12, and 13.

The computer system 1400 includes a processor 1402 that may be a special-purpose or a general-purpose processing device. The processor 1402 may be a single processor, multiple processors, or combinations thereof. The processor 1402 may have one or more processor cores. In one example, the processor 1402 is an octa-core processor. The processor 1402 may be connected to a communication infrastructure 1404, such as a bus, message queue, multi-core message-passing scheme, and the like. The computer system 1400 may further include a main memory 1406 and a secondary memory 1408. Examples of the main memory 1406 may include RAM, ROM, and the like. The secondary memory 1408 may include a hard disk drive or a removable storage drive, such as a floppy disk drive, a magnetic tape drive, a compact disc, an optical disk drive, a flash memory, and the like. The removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1400 further includes an input/output (I/O) interface 1410 and a communication interface 1412. The I/O interface 1410 includes various input and output devices that are configured to communicate with the processor 1402. Examples of the input devices may include a keyboard, a mouse, a joystick, a touchscreen, a microphone, and the like. Examples of the output devices may include a display screen, a speaker, headphones, and the like. The communication interface 1412 may be configured to allow data to be transferred between the computer system 1400 and various devices that are communicatively coupled to the computer system 1400. Examples of the communication interface 1412 may include a modem, a network interface, i.e., an Ethernet card, a communication port, and the like. Data transferred via the communication interface 1412 may correspond to signals, such as electronic, electromagnetic, optical, or other signals as will be apparent to a person skilled in the art. The signals may travel via a communication channel (not shown) which may be configured to transmit the signals to devices that are communicatively coupled to the computer system 1400. Examples of the communication channel may include, but are not limited to, cable, fiber optics, a phone line, a cellular phone link, a radio frequency link, and the like.

The main memory 1406 and the secondary memory 1408 are non-transitory computer readable mediums which may provide data that enables the computer system 1400 to implement the methods illustrated in FIGS. 11A-11B, 12, and 13. In an embodiment, the present invention may be implemented using a computer implemented application (for example, the service application 122) hosted by the computer system 1400. In such a scenario, the main memory 1406 and the secondary memory 1408 may computer executable instructions which when executed by the computer system 1400 cause the computer system 1400 to execute operations illustrated in FIGS. 11A-11B, 12, and 13.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into digitally any device. For instance, at least one processor such as the processor 1402 and a memory such as the main memory 1406 and the secondary memory 1408 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Thus, the environment 100 enhances convenience of making P2P payments by allowing a payer (for example, the first customer 102) to make payments to a payee (for example, the second customer 106 or the third customer 108) without requiring the payment credentials of the payee. Further, the invention allows the payer to make the payments using any payment mode preferred by the payer. The invention offers a variety of advantages to the financial institutions (such as issuers and payment networks), payers (such as the first customer 102), and intermediaries (such as the first and second intermediaries). As described in the foregoing, the invention enables the payment network server 114 to reverse a P2P payment when a payment amount of the P2P payment is not transferred to a financial account (such as a payment account or a digital wallet) of an intended payee (such as the second customer 106 or the third customer 108) within a time frame defined by the payment network server 114 or the payer. Further, the invention enables the payment network server 114 to block an amount equivalent to the payment account from financial accounts of intermediaries until the intended payee receives the payment amount. As a consequence, the P2P payment service offers a high level of security for the P2P payments and minimizes chances of fraud. Further, the payment network can achieve increased business by charging payers (such as the first customer 102) a nominal service fee for availing the P2P payment service. As described in the foregoing, the payment network may reward intermediaries (such as the first and second intermediaries), thereby, allowing the intermediaries to reap financial benefits when the intermediaries facilitate the P2P payments.

Techniques consistent with the present invention provide, among other features, systems and methods for facilitating P2P payments. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for facilitating peer-to-peer payments, the method comprising:
receiving, by a server from a payer device, a payment request initiated by a payer for making a payment of a first amount to a payee, wherein the payment request includes first and second identifiers of the payer and payee, respectively;
retrieving, by the server from a social platform, a set of links between the payer and payee based on the first and second identifiers such that each link of the set of links is indicative of a set of intermediaries that connects the payer to the payee on the social platform;
selecting, by the server from the set of links, a first link indicative of a first set of intermediaries; and
processing, by the server, the payment request by facilitating a transfer of the first amount from a first financial account of the payer to a second financial account of the payee by way of a first set of financial accounts of the first set of intermediaries.

2. The method of claim 1, wherein the payer and the first set of intermediaries are registered with the server.

3. The method of claim 1, further comprising communicating, by the server to an issuer associated with the first financial account, a debit request for debiting the first amount from the first financial account to facilitate the transfer of the first amount from the first financial account to the second financial account.

4. The method of claim 1, further comprising initiating, by the server, a credit of a second amount to the first set of financial accounts when the payee receives the first amount in the second financial account.

5. The method of claim 1, further comprising communicating, by the server, a notification to the payer device, indicating that the first amount is received by the payee in the second financial account.

6. The method of claim 1, wherein the first set of intermediaries includes at least one intermediary that receives the first amount in a third financial account and transfers the first amount to the second financial account, and wherein the first set of financial accounts includes the third financial account.

7. The method of claim 1, wherein the first link is selected by the server based on a count of intermediaries associated with each link of the set of links.

8. A system for facilitating peer-to-peer payments, the system comprising:
a payment network server that is configured to:
receive, from a payer device, a payment request initiated by a payer for making a payment of a first amount to a payee, wherein the payment request includes first and second identifiers of the payer and payee, respectively,
retrieve, from a social platform, a set of links between the payer and payee based on the first and second identifiers such that each link of the set of links is indicative of a set of intermediaries that connects the payer to the payee on the social platform,
select a first link indicative of a first set of intermediaries from the set of links, and
process the payment request by facilitating a transfer of the first amount from a first financial account of the payer to a second financial account of the payee by way of a first set of financial accounts of the first set of intermediaries.

9. The system of claim 8, wherein the payee and the first set of intermediaries are registered with the service application.

10. The system of claim 8, wherein the payment network server is further configured to communicate to an issuer associated with the first financial account a debit request for debiting the first amount from the first financial account to facilitate the transfer of the first amount from the first financial account to the second financial account.

11. The system of claim 8, wherein the payment network server is further configured to initiate a credit of a second amount to the first set of financial accounts when the payee receives the first amount in the second financial account.

12. The system of claim 8, wherein the payment network server is further configured to communicate, by way of the service application, a notification to the payee, indicating that the first amount is received by the payee in the second financial account.

13. The system of claim 8, wherein the first set of intermediaries includes a first intermediary that receives the first amount in a third financial account and transfers the first amount to the second financial account by way of the service application, and wherein the first set of financial accounts includes the third financial account.

14. The system of claim 8, wherein the server selects the first link based on a count of intermediaries associated with each link of the set of links.

15. A method for facilitating peer-to-peer payments, the method comprising:
receiving, by a server from a payer device, a payment request initiated by a payer for making a payment of a first amount to a payee, wherein the payment request includes first and second identifiers of the payer and payee, respectively;
retrieving, by the server from at least first and second social platforms, first and second social graphs of the payer and payee based on the first and second identifiers, respectively;
determining, by the server, a link connecting the payer and payee, based on the first and second social graphs such that the link is indicative of a set of intermediaries that connects the payer and payee; and
processing, by the server, the payment request by facilitating a transfer of the first amount from a first financial account of the payer to a second financial account of the payee by way of a set of financial accounts of the set of intermediaries.

16. The method of claim 15, wherein the payer and the set of intermediaries are registered with a service application hosted by the server.

17. The method of claim 15, further comprising communicating, by the server to an issuer associated with the first financial account, a debit request for debiting the first amount from the first financial account to facilitate the transfer of the first amount from the first financial account to the second financial account.

18. The method of claim 15, further comprising initiating, by the server, a credit of a second amount to the set of financial accounts when the payee receives the first amount in the second financial account.

19. The method of claim 15, further comprising communicating, by the server, a notification to the payer device, indicating that the first amount is received by the payee in the second financial account.

20. The method of claim 15, wherein the set of intermediaries includes at least one intermediary that receives the first amount in a third financial account and transfers the first amount to the second financial account, and wherein the set of financial accounts includes the third financial account.
